(19) United States
(12) Patent Application Publication
(10) Pub. No.: US 2025/0096967 A1
(43) Pub. Date: Mar. 20, 2025

(54) METHODS AND SYSTEMS FOR DETECTION OF CHANNEL VARIATIONS FOR WI-FI SENSING IN UNOBSERVED BANDWIDTH

(71) Applicant: COGNITIVE SYSTEMS CORP., Waterloo (CA)

(72) Inventors: Mohammad OMER, Waterloo, Ontario (CA); Chris BEG, Waterloo, Ontario (CA)

(21) Appl. No.: 18/724,404

(22) PCT Filed: Dec. 12, 2022
(86) PCT No.: PCT/IB2022/062087

§ 371 Date: Jun. 28, 2024

Related U.S. Application Data
(60) Provisional application No. 63/304,132, filed on Jan. 28, 2022.
(60) Provisional application No. 63/295,634, filed on Dec. 31, 2021.

(51) Int. Cl. H04L 5/00; H04W 72/0446

(52) U.S. Cl. CPC H04L 5/0048; H04W 72/0446

(57) ABSTRACT

Systems and methods for Wi-Fi sensing are provided. A method for Wi-Fi sensing carried out by a sensing device including a processor is described. Initially, first channel state information (CSI) of a first transmission channel representing a first sensing measurement performed on a first sensing transmission transmitted from a sensing transmitter to a sensing receiver in the first transmission channel may be received. A time-domain channel representation (TD-CRI) of the first CSI may be calculated by transforming the first CSI into the time domain. Then, a plurality of estimated channel responses corresponding to a plurality of transmission channels may be generated according to the TD-CRI. One or more preferred transmission channels from among the plurality of transmission channels may be determined according to the plurality of estimated channel responses.

### CROSS-REFERENCE TO RELATED APPLICATIONS

The present application claims benefit of U.S. Provisional Application No. 63/295,634, filed Dec. 31, 2021, and U.S. Provisional Application No. 63/304,132, filed Jan. 28, 2022, the entire contents of which are incorporated by reference herein.

### TECHNICAL FIELD

The present disclosure generally relates to methods and systems for Wi-Fi sensing. In particular, the present disclosure relates to methods and systems for detection of channel variations for Wi-Fi sensing in unobserved bandwidth.

### BACKGROUND OF THE DISCLOSURE

Motion detection systems have been used to detect movement, for example, of objects in a room or an outdoor area. In some example motion detection systems, infrared or optical sensors are used to detect the movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. For example, the Wi-Fi sensing system may include a sensing receiver and a sensing transmitter. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications. Features of interest may also be referred to as physical processes.

In the Wi-Fi sensing system, an orthogonal frequency division multiplexing (OFDM) channel may be represented by a channel representation information (CRI) in either frequency domain or time domain. In an example, frequency domain channel state information (CSI) is a common CRI which represents the OFDM channel by a phase and amplitude modifier for every subcarrier in an OFDM signal. In the time domain, one or more signal pulses may be received in the form of a number of multipath signals. Each multipath signal or time-domain pulse may undergo a different attenuation (amplitude and phase) and a different delay. The Wi-Fi sensing system may transmit sensing transmissions and/or make sensing measurements at different frequencies.

### BRIEF SUMMARY OF THE DISCLOSURE

The present disclosure generally relates to methods and systems for Wi-Fi sensing. In particular, the present disclosure relates to methods and systems for detection of channel variations for Wi-Fi sensing in unobserved bandwidth.

In certain situations, when the Wi-Fi sensing system is operating, channel perturbances in a sensing space due to a physical process in the sensing space (for example, motion or movement) may be easier to detect at some frequencies and may be harder to detect at other frequencies. This may be due to destructive or constructive interference of the delayed time-domain pulses.

The Wi-Fi sensing system may theoretically choose frequencies at which to operate in order to accurately detect a physical process. To determine the most effective frequency at which to transmit the sensing transmissions and/or make the sensing measurements in order to accurately detect the physical process, the Wi-Fi sensing system may use “trial and error” method by measuring some or all available frequencies in order to determine one or more frequencies that assist in easy detection of the physical process. However, use of the “trial and error” method is not practical and is inefficient as the Wi-Fi sensing system may not have the flexibility to measure some or all available frequencies.

Systems and methods are provided for Wi-Fi sensing. In an example embodiment, a method for Wi-Fi sensing is described. The method is carried out by a sensing device including at least one processor configured to execute instructions. The method includes receiving, by the at least one processor, first channel state information (CSI) of a first transmission channel representing a first sensing measurement performed on a first sensing transmission transmitted from a sensing transmitter to a sensing receiver in the first transmission channel; calculating, based on the first CSI, a time-domain channel representation (TD-CRI) of the first CSI by transforming the first CSI into the time domain; generating, by the at least one processor, a plurality of estimated channel responses corresponding to a plurality of transmission channels according to the TD-CRI; and determining, by the at least one processor, one or more preferred transmission channels from among the plurality of transmission channels according to the plurality of estimated channel responses.

In some embodiments, the TD-CRI is a filtered TD-CRI or a full TD-CRI.

In some embodiments, generating the plurality of estimated channel responses includes extracting complex coefficients and time delays of pulses defined by the TD-CRI; and calculating a frequency domain representation of one or more frequency bands according to the complex coefficients and the time delays.

In some embodiments, generating the plurality of estimated channel responses further includes calculating each of the plurality of estimated channel responses as a response to a frequency of each of the plurality of transmission channels in the one or more frequency bands according to the frequency domain representation of the sensing space.

In some embodiments, the frequency of each of the plurality of transmission channels represents a tunable frequency of the sensing transmitter or a range of tunable frequencies of the sensing transmitter.

In some embodiments, determining the one or more preferred transmission channels includes determining a preferential order of the plurality of transmission channels according to sorted magnitudes of corresponding ones of the plurality of estimated channel responses.

In some embodiments, determining the one or more preferred transmission channels further includes determining a preferential order of sensing channel frequencies according to a mapping between the plurality of transmission channels and tunable frequencies of the sensing transmitter.

In some embodiments, determining the one or more preferred transmission channels further includes eliminating transmission channels having a magnitude of a corresponding estimated channel response below a magnitude floor.

In some embodiments, the method comprises causing transmission of a sensing trigger message configured to trigger the sensing transmitter to make a second sensing transmission in a selected one of the one or more preferred transmission channels.

In some embodiments, the method comprises causing transmission of a sensing trigger message configured to trigger the sensing transmitter to make a second sensing transmission according to the preferential order of the plurality of transmission channels.

In some embodiments, the method comprises causing the sensing receiver to tune to the selected one of the one or more preferred transmission channels.

In some embodiments, the method comprises causing the sensing receiver to tune to a transmission channel according to the preferential order of the plurality of transmission channels.

In some embodiments, the method comprises receiving second CSI of a selected one of the one or more preferred transmission channels representing a second sensing measurement performed on a second sensing transmission transmitted from the sensing transmitter to the sensing receiver in the selected one of the one or more preferred transmission channels.

In some embodiments, the method comprises prioritizing second CSI determined based on second sensing measurements performed on second sensing transmissions in the one or more preferred transmission channels over third CSI determined based on third sensing measurements performed on third sensing transmissions in non-preferred transmission channels.

In some embodiments, the method comprises analyzing second CSI determined based on second sensing measurements performed on second sensing transmissions in the one or more preferred transmission channels while in a first mode; and analyzing, by the at least one processor, third CSI determined based on third sensing measurements performed on third sensing transmissions in preferred and non-preferred transmission channels while in a second mode.

In some embodiments, the method comprises receiving one or more input parameters; and selecting the one or more preferred transmission channels according to the preferential order of the plurality of transmission channels and the one or more input parameters.

In another example embodiment, a system for Wi-Fi sensing is described. The system includes a sensing device including at least one processor configured to execute instructions for: receiving first channel state information (CSI) of a first transmission channel representing a first sensing measurement performed on a first sensing transmission transmitted from a sensing transmitter to a sensing receiver in the first transmission channel; calculating, based on the first CSI, a time-domain channel representation (TD-CRI) of the first CSI by transforming the first CSI into the time domain; generating a plurality of estimated channel responses corresponding to a plurality of transmission channels accordingly to the TD-CRI; and determining one or more preferred transmission channels from among the plurality of transmission channels accordingly to the plurality of estimated channel responses.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts an implementation of some of an architecture of an implementation of a system for Wi-Fi sensing, according to some embodiments;

FIG. 6 illustrates a management frame carrying a sensing transmission, according to some embodiments;

FIG. 7A illustrates an example of a format of a control frame and FIG. 7B illustrates a format of a sensing transmission control field of the control frame, according to some embodiments;

FIG. 8A illustrates another example of a format of a control frame and FIG. 8B illustrates a format of a sensing measurement control field of the control frame, according to some embodiments;

FIG. 9 illustrates a management frame carrying a CRI transmission message, according to some embodiments;

FIG. 10 depicts an example representation of a transmission channel, which includes a direct signal path and a single multipath, according to some embodiments;

FIG. 11 depicts an example representation of a transmission channel, which includes a received signal with a single reflected path, according to some embodiments;

FIG. 12 depicts an example frequency domain representation of the received signal with the single reflected path, according to some embodiments;

FIG. 13 depicts an example representation of a transmission channel, which includes a received signal with two reflected path, according to some embodiments;

FIG. 14 depicts an example frequency domain representation of the received signal with the two reflected paths, according to some embodiments;

FIG. 15 depicts an example time domain representation of a received signal with a single reflected path modulated by a physical process including amplitude variations, according to some embodiments;

FIG. 16 depicts an example time domain representation of a received signal with a single reflected path modulated by a physical process including amplitude variations and time delay variations, according to some embodiments;

FIG. 17 depicts an example frequency domain representation of a received signal with a single reflected path modulated by a physical process including amplitude variations showing a 20 MHz bandwidth transmission channel, according to some embodiments;

FIG. 18 depicts an example frequency domain representation of a received signal with a single reflected path modulated by a physical process including amplitude variations showing two 20 MHz bandwidth transmission channels, according to some embodiments;

FIG. 19 depicts a flowchart for determining preferred transmission channels from among a plurality of transmission channels, according to some embodiments;

FIG. 20A and FIG. 20B depict a flowchart for causing a transmission of a sensing trigger message configured to trigger a sensing transmitter to make a second sensing transmission in a selected one of preferred transmission channels, according to some embodiments;

FIG. 21A and FIG. 21B depict a flowchart for causing a transmission of a sensing trigger message configured to trigger the sensing transmitter to make a second sensing transmission according to a preferential order of plurality of transmission channels, according to some embodiments;

FIG. 22A and FIG. 22B depict a flowchart for causing a sensing receiver to tune to a selected one of preferred transmission channels, according to some embodiments; and

FIG. 23A and FIG. 23B depict a flowchart for causing the sensing receiver to tune to a transmission channel according to a preferential order of a plurality of preferred transmission channels, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering) and may reduce processing (less data to correlate or filter).

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with a good signal strength. The coverage footprint of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “channel state information (CSI)” may refer to properties of a communications channel that are known or measured by a technique of channel estimation. CSI may represent how wireless signals propagate from a transmitter (for example, a sensing transmitter) to a receiver (for example, a sensing receiver) along multiple paths. CSI is typically a matrix of complex values representing the amplitude attenuation and phase shift of signals, which provides an estimation of a communications channel.

A term “full time-domain channel representation information (full TD-CRI)” may refer to a series of complex pairs of time domain pulses which are created by performing an Inverse Fourier transform on CSI values, for example CSI calculated by a baseband receiver.

A term “channel representation information (CRI)” may refer to a collection of sensing measurements which together represent the state of the channel between two devices. Examples of CRI are CSI and full TD-CRI.

A term “filtered time-domain channel representation information (filtered TD-CRI)” may refer to a reduced series of complex pairs of time domain pulses created by applying an algorithm to a full TD-CRI. The algorithm may select some time domain pulses and reject others. The filtered TD-CRI includes information that relates a selected time domain pulse to the corresponding time domain pulse in the full TD-CRI.

A term “discrete Fourier transform (DFT)” may refer to an algorithm that transforms a signal in time domain to a signal in frequency domain. In an embodiment, a fast Fourier transform (FFT) may be used to implement the DFT.

A term “inverse discrete Fourier transform (IDFT)” may refer to an algorithm which transforms a signal in frequency domain to a signal in time domain. In an example, the IDFT may be used to transform a CSI into a TD-CRI. In an embodiment, an inverse fast Fourier transform (IFFT) may be used to implement the IDFT.

A term “sensing initiator” may refer to a device that initiates a Wi-Fi sensing session. The role of sensing initiator may be taken on by the sensing receiver, the sensing transmitter, or a separate device which includes a sensing algorithm (for example, a sensing device).

A term “PHY-layer Protocol Data Unit (PPDU)” may refer to a data unit that includes preamble and data fields. The preamble field may include the transmission vector format information and the data field may include payload and higher layer headers.

A term “Null Data PPDU (NDP)” may refer to a PPDU that does not include data fields. In an example, Null Data PPDU may be used for sensing transmission where it is the MAC header that includes the information required.

A term “sensing transmission” may refer to any transmission made from a sensing transmitter to a sensing receiver which may be used to make a sensing measurement. In an example, sensing transmission may also be referred to as wireless sensing signal or wireless signal.

A term “sensing trigger message” may refer to a message sent from the sensing receiver to the sensing transmitter to trigger one or more sensing transmissions that may be used for performing sensing measurements. In an example, a sensing trigger message may be sent from a sensing transmitter to a sensing receiver to cause the sensing receiver to send a sensing measurement response message back to the sensing transmitter or to a sensing initiator.

A term “sensing response message” may refer to a message which is included within a sensing transmission from the sensing transmitter to the sensing receiver. In an example, the sensing transmission that includes the sensing response message may be used to perform a sensing measurement.

A term “sensing measurement” may refer to a measurement of a state of a channel i.e., CSI measurement between the sensing transmitter and the sensing receiver derived from a transmission, for example a sensing transmission.

A term “transmission parameters” may refer to a set of IEEE 802.11 PHY transmitter configuration parameters which are defined as part of transmission vector (TXVECTOR) corresponding to a specific PHY and which are configurable for each PHY-layer Protocol Data Unit (PPDU) transmission.

A term “sensing transmitter” may refer to a device that sends a transmission (for example, NDP and PPDUs) used for sensing measurements (for example, channel state information) in a sensing session. In an example, a station is an example of a sensing transmitter. In some examples, an access point (AP) may also be a sensing transmitter for Wi-Fi sensing purposes in the example where a station acts as a sensing receiver.

A term “sensing receiver” may refer to a device that receives a transmission (for example, NDP and PPDUs or any other transmission which may be opportunistically used for sensing measurements) sent by a sensing transmitter and performs one or more sensing measurements (for example, channel state information) in a sensing session. An access point (AP) is an example of a sensing receiver. In some examples, a station may also be a sensing receiver in a mesh network scenario.

A term “channel response information (CRI) transmission message” may refer to a message sent by the sensing receiver that has performed a sensing measurement on a sensing transmission, in which the sensing receiver sends CRI to a sensing initiator or the sensing device.

A term “time domain pulse” may refer to a complex number that represents amplitude and phase of discretized energy in the time domain. When CSI values are obtained for each tone from the baseband receiver, time domain pulses are obtained by performing an inverse Fourier Transform (for example an IDFT or an IFFT) on the CSI values.

A term “delivered transmission configuration” may refer to transmission parameters applied by the sensing transmitter to a sensing transmission.

A term “requested transmission configuration” may refer to requested transmission parameters of the sensing transmitter to be used when sending a sensing transmission.

A term “physical process” may refer to a motion or a movement that takes place in a sensing space which causes reflections of a transmitted signal between the sensing transmitter and the sensing receiver in the sensing space.

A “transmission channel” may refer to a tunable channel on which the sensing receiver performs a sensing measurement and/or on which the sensing transmitter performs a sensing transmission.

A term “sensing transmission announcement message” may refer to a message which is sent from the sensing transmitter to the sensing receiver that announces that a sensing transmission NDP will follow within a short interframe space (SIFS). The sensing transmission NDP may be transmitted using transmission parameters defined with the sensing transmission announcement messages.

A term “sensing transmission NDP” may refer to an NDP transmission which is sent by the sensing transmitter and used for a sensing measurement at the sensing receiver. The transmission follows a sensing transmission announcement and may be transmitted using transmission parameters that are defined in the sensing response announcement.

A term “sensing measurement poll message” may refer to a message which is sent from the sensing transmitter to the sensing receiver to solicit the transmission of channel representation information which has been determined by the sensing receiver.

A term “sensing configuration message” may refer to a message which from a device including a sensing algorithm (for example, a sensing device) to the sensing receiver. The sensing configuration message may include a channel representation information configuration. The channel representation information configuration may interchangeably be referred to as Time Domain Channel Representation Information (TD-CRI) configuration.

A term “sensing configuration response message” may refer to a message sent from the sensing receiver to the device including the sensing algorithm (for example, the sensing device) in response to a sensing configuration message. In an example, the sensing configuration response message may be an acknowledgement to the sensing configuration message.

A term “system administrator” may refer to an individual or a team who oversees a Wi-Fi sensing system and manages sensing elements on devices connected in a network.

A term “feature of interest” may refer to item or state of an item which is positively detected and/or identified by a sensing algorithm.

A term “Wi-Fi sensing session” may refer to a period during which objects in a physical space may be probed, detected and/or characterized. In an example, during a Wi-Fi sensing session, several devices participate in, and thereby contribute to the generation of sensing measurements. A Wi-Fi sensing session may also be referred to as a wireless local area network (WLAN) sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configurated to send sensing transmissions and make sensing measurements.

Section C describes embodiments of methods and systems for detection of channel variations for W-Fi sensing in unobserved bandwidth.

### A. Wireless Communications System, Wireless Transmissions, and Sensing Measurements

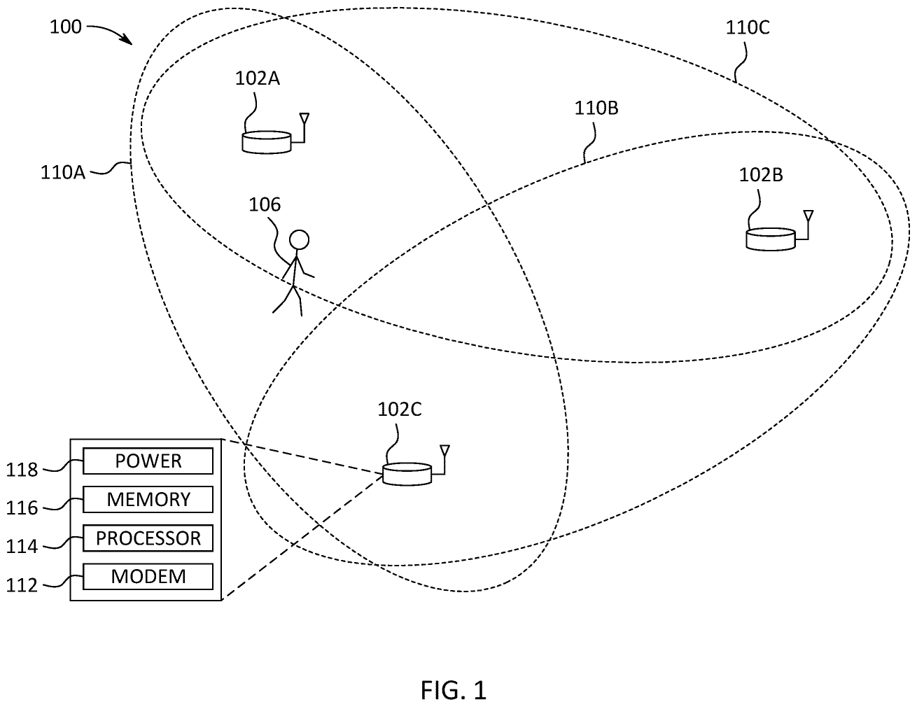

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals and sends the baseband signals to the baseband subsystem. The signals exchanged between the radio subsystem, and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

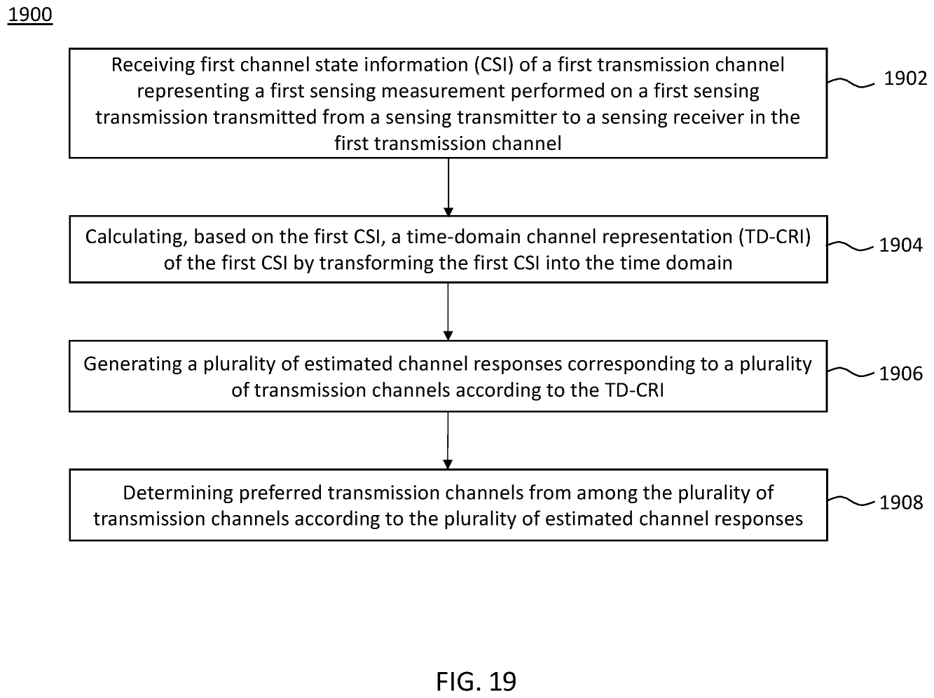

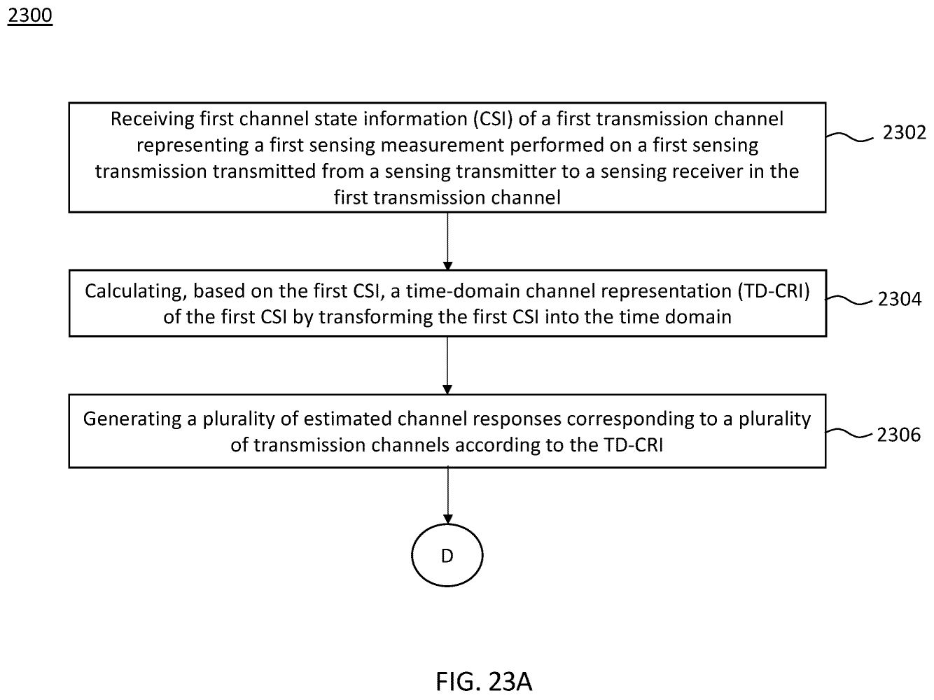

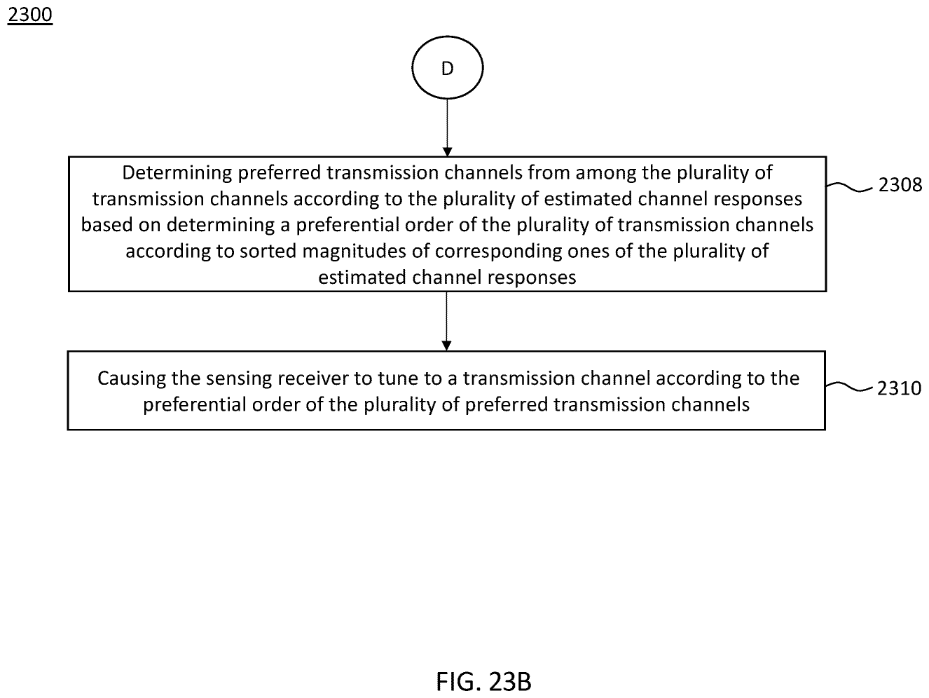

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIG. 19, 20A, 20B, 21A, 21B, 22A, 22B, 23A, and FIG. 23B.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current adapter, or AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIG. 19, 20A, 20B, 21A, 21B, 22A, 22B, 23A, and FIG. 23B, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in wireless communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

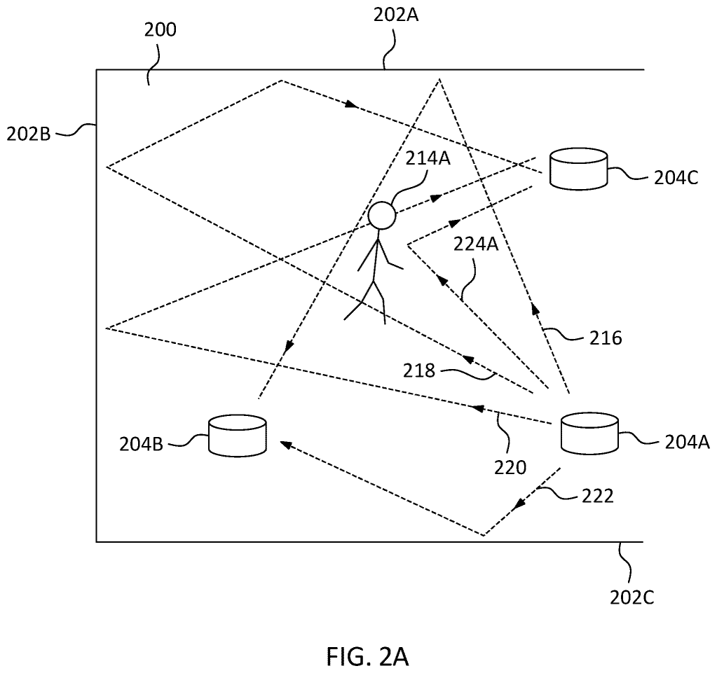

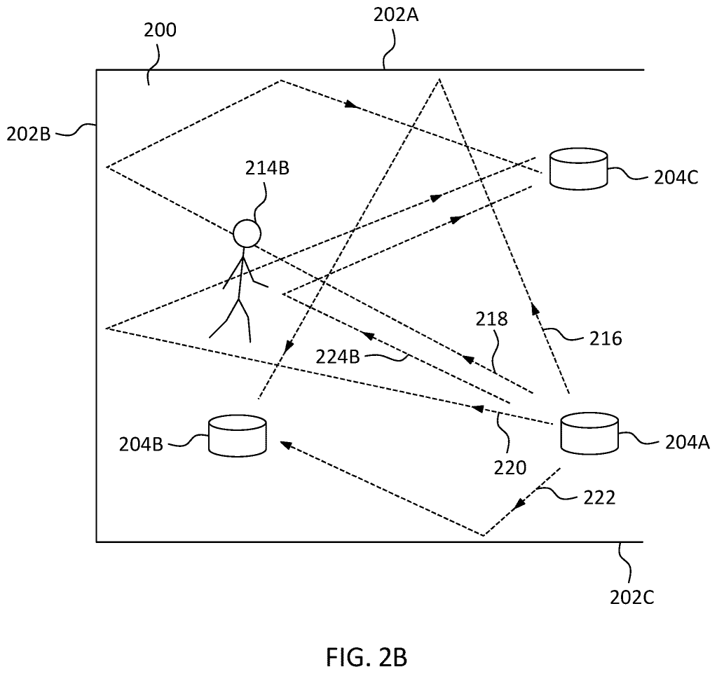

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f (t) transmitted from the first wireless communication device 204A may be described according to Equation (1):

$$f ( t ) = {\sum }_{n = - ∞}^{∞} {c}_{n} {e}^{j {ω}_{{n}^{t}}} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component ωₙ indicates a relative magnitude and phase offset of the received signal at that frequency component ωₙ. When an object moves in the space, the complex value Hₙ changes due to the channel response α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal R_{ef} can be modified with candidate channel responses (h_{ch}), and then a maximum likelihood approach can be used to select the candidate channel which gives a best match to the received signal (R_{cvd}). In some cases, an estimated received signal (\hat{R}_{cvd}) is obtained from the convolution of the reference signal (R_{ef}) with the candidate channel responses (h_{ch}), and then the channel coefficients of the channel response (h_{ch}) are varied to minimize the squared error of the estimated received signal (\hat{R}_{cvd}). This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{ch}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

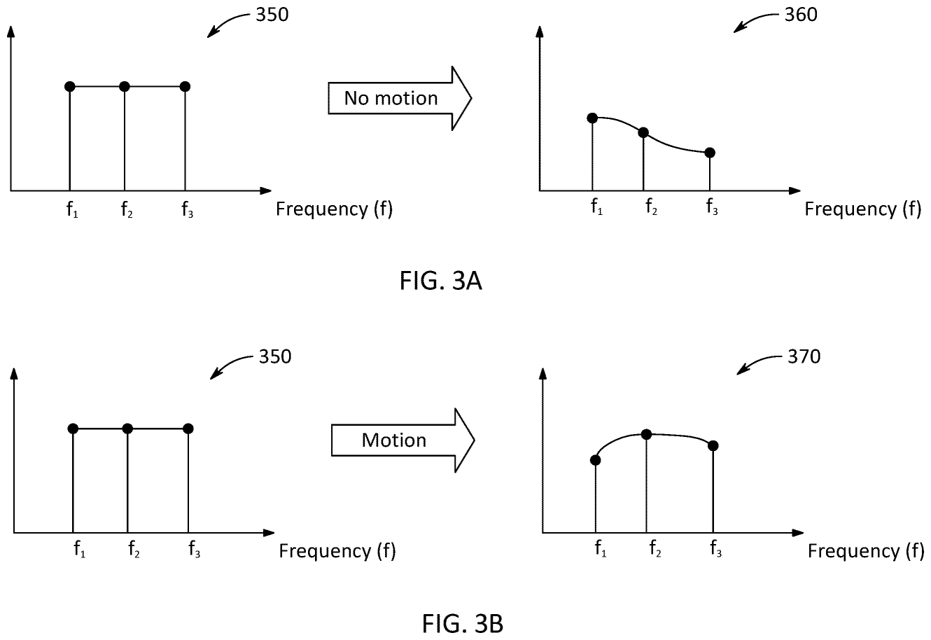

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

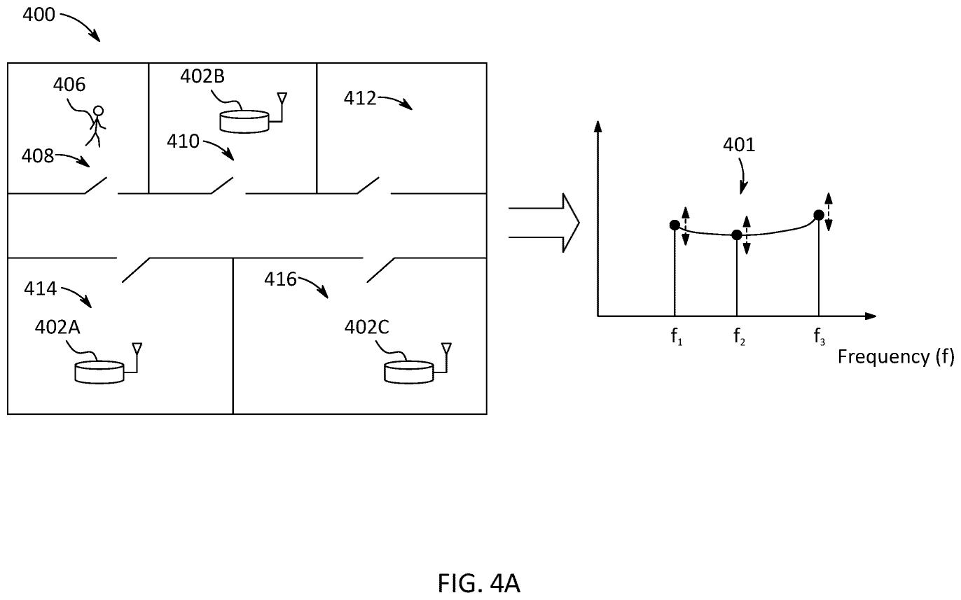

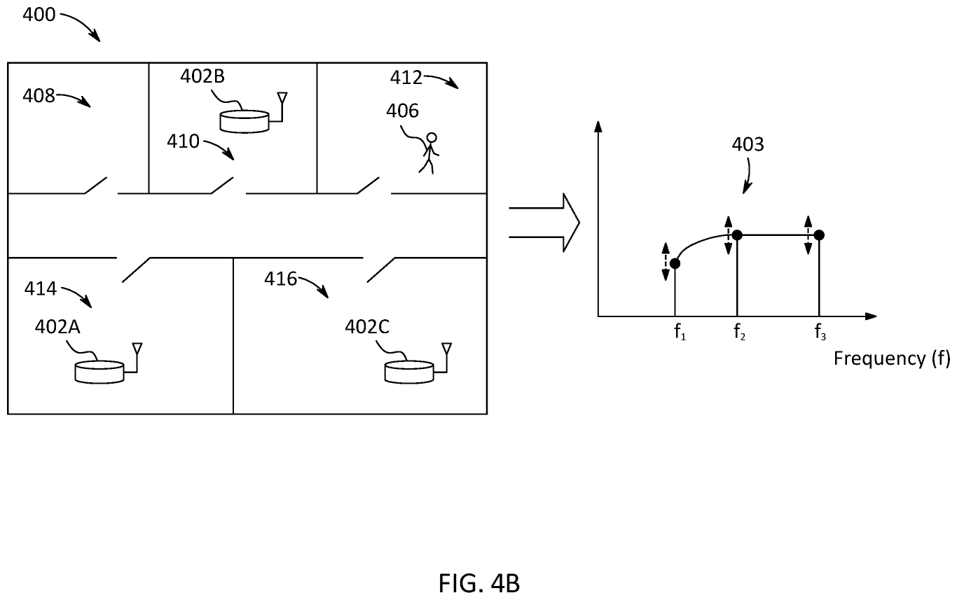

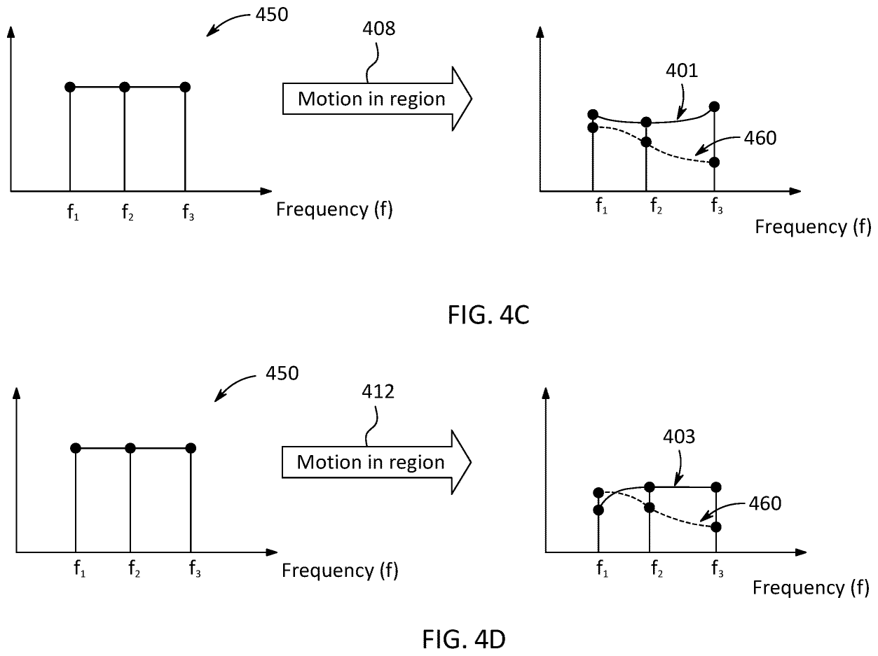

FIG. 4A and FIG. 4B are diagrams showing example channel responses 401, 403 associated with motion of object 406 in distinct regions 408, 412 of space 400 (in an example, space 400 may be a sensing space). In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component of f₁, f₂, and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. FIG. 4C and FIG. 4D also show frequency domain representation 450 of an initial wireless signal transmitted by one or more of wireless communication devices 402A, 402B, 402C. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence mode or AI model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component of each of f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a Wi-Fi sensing system configurated to send sensing transmissions and make sensing measurements.

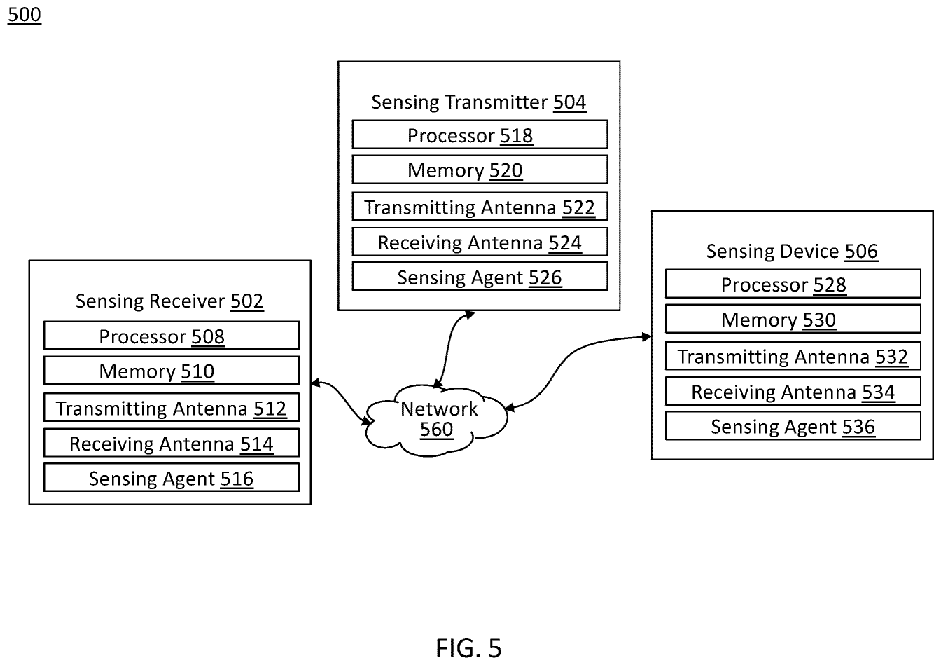

FIG. 5 depicts an implementation of some of an architecture of an implementation of system 500 for Wi-Fi sensing, according to some embodiments.

System 500 may include sensing receiver 502, sensing transmitter 504, sensing device 506, and network 560 enabling communication between the system components for information exchange. System 500 may be an example or instance of wireless communication system 100, and network 560 may be an example or instance of wireless network or cellular network, details of which are provided with reference to FIG. 1 and its accompanying description.

According to an embodiment, sensing receiver 502 may be configured to receive a sensing transmission (for example, from sensing transmitter 504) and perform one or more measurements (for example, channel state information (CSI)) useful for Wi-Fi sensing. These measurements may be known as sensing measurements. The sensing measurements may be processed to achieve a sensing result of system 500, such as detecting motions or gestures. In an embodiment, sensing receiver 502 may be an AP. In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIG. 2A and FIG. 2B. Further, sensing receiver 502 may be implemented by a device, such as wireless communication device 402 shown in FIG. 4A and FIG. 4B. In some embodiments, sensing receiver 502 may be any computing device, such as a desktop computer, a laptop, a tablet computer, a mobile device, a personal digital assistant (PDA), or any other computing device. According to an implementation, sensing receiver 502 may be enabled to control a measurement campaign to ensure that required sensing transmissions are made at a required time and to ensure an accurate determination of sensing measurements. In some embodiments, sensing receiver 502 may process sensing measurements to achieve the sensing result of system 500. In some embodiments, sensing receiver 502 may be configured to transmit sensing measurements to sensing transmitter 504 or sensing device 506, and sensing transmitter 504 or sensing device 506 may be configured to process the sensing measurements to achieve the sensing result of system 500.

Referring again to FIG. 5, in some embodiments, sensing transmitter 504 may form a part of a basic service set (BSS) and may be configured to send a sensing transmission to sensing receiver 502. In an embodiment, sensing transmitter 504 may be a station. In an embodiment sensing transmitter 504 may be an access point. According to an implementation, sensing transmitter 504 may be implemented by a device, such as wireless communication device 102 shown in FIG. 1. In some implementations, sensing transmitter 504 may be implemented by a device, such as wireless communication device 204 shown in FIG. 2A and FIG. 2B. Further, sensing transmitter 504 may be implemented by a device, such as wireless communication device 402 shown in FIG. 4A and FIG. 4B. In some embodiments, sensing transmitter 504 may be any computing device, such as a desktop computer, a laptop, a tablet computer, a mobile device, a personal digital assistant (PDA), or any other computing device. In some implementations, communication between sensing receiver 502 and sensing transmitter 504 may happen via station management entity (SME) and MAC layer management entity (MLME) protocols.

In some embodiments, sensing device 506 may be configured to receive sensing measurements from sensing receiver 502 or sensing transmitter 504 and process the sensing measurements. In an example, sensing device 506 may process and analyze sensing measurements to identify one or more features of interest. According to some implementations, sensing device 506 may include/execute a sensing algorithm. In an embodiment, sensing device 506 may be a station. In some embodiments, sensing device 506 may be an AP. According to an implementation, sensing device 506 may be implemented by a device, such as wireless communication device 102 shown in FIG. 1. In some implementations, sensing device 506 may be implemented by a device, such as wireless communication device 204 shown in FIG. 2A and FIG. 2B. Further, sensing device 506 may be implemented by a device, such as wireless communication device 402 shown in FIG. 4A and FIG. 4B. In some embodiments, sensing device 506 may be any computing device, such as a desktop computer, a laptop, a tablet computer, a mobile device, a personal digital assistant (PDA), or any other computing device. In embodiments, sensing device 506 may take a role of sensing initiator where a sensing algorithm determines a measurement campaign and the sensing measurements required to fulfill the measurement campaign. In an implementation, sensing device 506 may control sensing receiver 502 and sensing transmitter 504 in order to detect and measure a physical process in a sensing space.

Referring to FIG. 5, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna 512, receiving antenna 514, and sensing agent 516. In some embodiments, an antenna may be used to both transmit and receive signals in a half-duplex format. When the antenna is transmitting, it may be referred to as transmitting antenna 512, and when the antenna is receiving, it may be referred to as receiving antenna 514. It is understood by a person of normal skill in the art that the same antenna may be transmitting antenna 512 in some instances and receiving antenna 514 in other instances. In the case of an antenna array, one or more antenna elements may be used to transmit or receive a signal, for example, in a beamforming environment. In some examples, a group of antenna elements used to transmit a composite signal may be referred to as transmitting antenna 512, and a group of antenna elements used to receive a composite signal may be referred to as receiving antenna 514. In some examples, each antenna is equipped with its own transmission and receive paths, which may be alternately switched to connect to the antenna depending on whether the antenna is operating as transmitting antenna 512 or receiving antenna 514.

In an implementation, sensing agent 516 may be responsible for receiving sensing transmissions and associated transmission parameters, calculating sensing measurements, and processing sensing measurements to fulfill a sensing goal. In some implementations, receiving sensing transmissions and associated transmission parameters, and calculating sensing measurements may be carried out by an algorithm running in the Medium Access Control (MAC) layer of sensing receiver 502 and processing sensing measurements to fulfill a sensing goal may be carried out by an algorithm running in the application layer of sensing receiver 502. In some examples, the algorithm running in the application layer of sensing receiver 502 is known as a sensing application or sensing algorithm. In some implementations, the algorithm running in the MAC layer of sensing receiver 502 and the algorithm running in the application layer of sensing receiver 502 may run separately on processor 508. In an implementation, sensing agent 516 may pass physical layer parameters (e.g., such as CSI) from the MAC layer of sensing receiver 502 to the application layer of sensing receiver 502 and may use the physical layer parameters to detect one or more features of interest. In an example, the application layer may operate on the physical layer parameters and form services or features, which may be presented to an end-user. According to an implementation, communication between the MAC layer of sensing receiver 502 and other layers or components may take place based on communication interfaces, such as MLME interface and a data interface. According to some implementations, sensing agent 516 may include/execute a sensing algorithm. In an implementation, sensing agent 516 may process and analyze sensing measurements using the sensing algorithm and identify one or more features of interest. Further, sensing agent 516 may be configured to determine a number and timing of sensing transmissions and sensing measurements for the purpose of Wi-Fi sensing. In some implementations, sensing agent 516 may be configured to transmit sensing measurements to sensing transmitter 504 or sensing device 506 for further processing.

In an implementation, sensing agent 516 may be configured to cause at least one transmitting antenna 512 to transmit messages to sensing transmitter 504 or sensing device 506. Further, sensing agent 516 may be configured to receive, via at least one receiving antenna 514, messages from sensing transmitter 504. In an example, sensing agent 516 may be configured to make sensing measurements based on one or more sensing transmissions received from sensing transmitter 504. According to an implementation, sensing agent 516 may be configured to process and analyze the sensing measurements to identify one or more features of interest.

Referring again to FIG. 5, sensing transmitter 504 may include processor 518 and memory 520. For example, processor 518 and memory 520 of sensing transmitter 504 may be processor 114 and memory 116, respectively, as shown in FIG. 1. In an embodiment, sensing transmitter 504 may further include transmitting antenna 522, receiving antenna 524, and sensing agent 526. In an implementation, sensing agent 526 may be a block that passes physical layer parameters from the MAC of sensing transmitter 504 to application layer programs. Sensing agent 526 may be configured to cause at least one transmitting antenna 522 and at least one receiving antenna 524 to exchange messages with sensing receiver 502.

In some embodiments, an antenna may be used to both transmit and receive in a half-duplex format. When the antenna is transmitting, it may be referred to as transmitting antenna 522, and when the antenna is receiving, it may be referred to as receiving antenna 524. It is understood by a person of normal skill in the art that the same antenna may be transmitting antenna 522 in some instances and receiving antenna 524 in other instances. In the case of an antenna array, one or more antenna elements may be used to transmit or receive a signal, for example, in a beamforming environment. In some examples, a group of antenna elements used to transmit a composite signal may be referred to as transmitting antenna 522, and a group of antenna elements used to receive a composite signal may be referred to as receiving antenna 524. In some examples, each antenna is equipped with its own transmission and receive paths, which may be alternately switched to connect to the antenna depending on whether the antenna is operating as transmitting antenna 522 or receiving antenna 524.

In an implementation, sensing agent 526 may be responsible for receiving sensing measurements and associated transmission parameters, calculating sensing measurements, and/or processing sensing measurements to fulfill a sensing goal. In some implementations, receiving sensing measurements and associated transmission parameters, and calculating sensing measurements and/or processing sensing measurements may be carried out by an algorithm running in the Medium Access Control (MAC) layer of sensing transmitter 504 and processing sensing measurements to fulfill a sensing goal may be carried out by an algorithm running in the application layer of sensing transmitter 504. In some examples, the algorithm running in the application layer of sensing transmitter 504 is known as a sensing application or sensing algorithm. In some implementations, the algorithm running in the MAC layer of sensing transmitter 504 and the algorithm running in the application layer of sensing transmitter 504 may run separately on processor 518. In an implementation, sensing agent 526 may pass physical layer parameters (e.g., such as CSI) from the MAC layer of sensing transmitter 504 to the application layer of sensing transmitter 504 and may use the physical layer parameters to detect one or more features of interest. In an example, the application layer may operate on the physical layer parameters and form services or features, which may be presented to an end-user. According to an implementation, communication between the MAC layer of sensing transmitter 504 and other layers or components may take place based on communication interfaces, such as MLME interface and a data interface. According to some implementations, sensing agent 526 may include/execute a sensing algorithm. In an implementation, sensing agent 526 may process and analyze sensing measurements using the sensing algorithm and identify one or more features of interest. Further, sensing agent 526 may be configured to determine a number and timing of sensing transmissions and sensing measurements for the purpose of Wi-Fi sensing. In some implementations, sensing agent 526 may be configured to transmit sensing measurements to or sensing device 506 for further processing.

In an implementation, sensing agent 526 may be configured to cause at least one transmitting antenna 522 to transmit messages to sensing device 506. Further, sensing agent 526 may be configured to receive, via at least one receiving antenna 524, messages from sensing receiver 502 or sensing device 506. In an example, sensing agent 526 may be configured to receive sensing measurements from sensing transmitter 504. According to an implementation, sensing agent 526 may be configured to process and analyze the sensing measurements to identify one or more features of interest.

Referring again to FIG. 5, sensing device 506 may include processor 528 and memory 530. For example, processor 528 and memory 530 of sensing device 506 may be processor 114 and memory 116, respectively, as shown in FIG. 1. In an embodiment, sensing device 506 may further include transmitting antenna 532, receiving antenna 534, and sensing agent 536. In an implementation, sensing agent 536 may be a block that passes physical layer parameters from the MAC of sensing device 506 to application layer programs. Sensing agent 536 may be configured to cause at least one transmitting antenna 532 and at least one receiving antenna 534 to exchange messages with sensing receiver 502.

In some embodiments, an antenna may be used to both transmit and receive in a half-duplex format. When the antenna is transmitting, it may be referred to as transmitting antenna 512/522/532, and when the antenna is receiving, it may be referred to as receiving antenna 514/524/534. It is understood by a person of normal skill in the art that the same antenna may be transmitting antenna 512/522/532 in some instances and receiving antenna 514/524/534 in other instances. In the case of an antenna array, one or more antenna elements may be used to transmit or receive a signal, for example, in a beamforming environment. In some examples, a group of antenna elements used to transmit a composite signal may be referred to as transmitting antenna 512/522/532, and a group of antenna elements used to receive a composite signal may be referred to as receiving antenna 514/524/534. In some examples, each antenna is equipped with its own transmission and receive paths, which may be alternately switched to connect to the antenna depending on whether the antenna is operating as transmitting antenna 512/522/532 or receiving antenna 514/524/534.

Although sensing device 506 is shown in FIG. 5 as a functional block separate from sensing receiver 502 and sensing transmitter 504, in an embodiment of system 500, sensing device 506 may be implemented by sensing receiver 502 or by sensing transmitter 504. In embodiments, sensing agent 516 of sensing receiver 502 or sensing agent 526 or sensing transmitter 504 may implement the functionality of sensing device 506.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az, and IEEE 802.11be. IEEE 802.11-2020 and IEEE 802.11ax-2021 are fully-ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards, adding new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network.

Referring to FIG. 5, according to one or more implementations, for the purpose of Wi-Fi sensing, the role of sensing initiator may be taken on by sensing receiver 502. In an implementation, sensing device 506 may send a sensing configuration message to sensing receiver 502. In an example, the sensing configuration message may include a channel representation information configuration. In response to the sensing configuration message, sensing receiver 502 may send an acknowledgment using a sensing configuration response message and configure itself with the channel representation information configuration for use in generating TD-CRI. Thereafter, in an example, sensing receiver 502 may initiate a sensing session and send a sensing trigger message to sensing transmitter 504 requesting a sensing transmission. Sensing transmitter 504 may then send a sensing transmission to sensing receiver 502 in response to the sensing trigger message. Upon receiving the sensing transmission, sensing receiver 502 may perform a channel state measurement on the received sensing transmission and generate channel representation information using the channel representation information configuration. In an example, sensing receiver 502 may generate TD-CRI. Further, sensing receiver 502 may send a CRI transmission message including the channel state measurement (i.e., the TD-CRI) to sensing device 506 for further processing.

According to some embodiments, the role of sensing initiator may be taken on by sensing transmitter 504. In an implementation, sensing device 506 may send a sensing configuration message to sensing receiver 502. In an example, the sensing configuration message may include a channel representation information configuration. In response to the sensing configuration message, sensing receiver 502 may send an acknowledgment using a sensing configuration response message and configure itself with the channel representation information configuration for use in generating TD-CRI. Thereafter, sensing transmitter 504 may initiate a sensing session and send a sensing transmission announcement message followed by a sensing transmission NDP to sensing receiver 502. In an example, the sensing transmission NDP follows the sensing transmission announcement message after one SIFS. In an example, the duration of SIFS is 10 μs. Sensing receiver 502 may perform a channel state measurement on the sensing transmission NDP and generate channel representation information based on the channel representation information configuration. In an example, the sensing receiver 502 may generate TD-CRI. Sensing receiver 502 may send a CRI transmission message including the channel state measurement (i.e., the TD-CRI) to sensing device 506 for further processing.

According to some embodiments, sensing transmitter 504 may initiate a sensing session and send a sensing transmission announcement message followed by a sensing transmission NDP to sensing receiver 502. In an example, the sensing transmission announcement message may include a channel representation information configuration. In an example, the sensing transmission NDP follows the sensing transmission announcement message after one SIFS. In an example, the duration of SIFS is 10 μs. In an implementation, sensing receiver 502 may perform a channel state measurement on the sensing transmission NDP and generate channel representation information based on the channel representation information configuration. In an example, the sensing receiver 502 may generate TD-CRI. In an example, sensing receiver 502 may hold the channel state measurement until it receives a sensing measurement poll message. Sensing transmitter 504 may send a sensing measurement poll message to sensing receiver 502, which may trigger sensing receiver 502 to send an already formatted channel state measurement (i.e., TD-CRI) to sensing transmitter 504. In another example, sensing transmitter 504 may send a sensing measurement poll message to sensing receiver 502 which includes a channel representation information configuration. The sensing measurement poll message may trigger sensing receiver 502 to generate TD-CRI according to the channel representation information configuration, and to transfer the TD-CRI to sensing transmitter 504. Sensing receiver 502 may send a CRI transmission message including the channel state measurement (i.e., the TD-CRI) to sensing device 506.

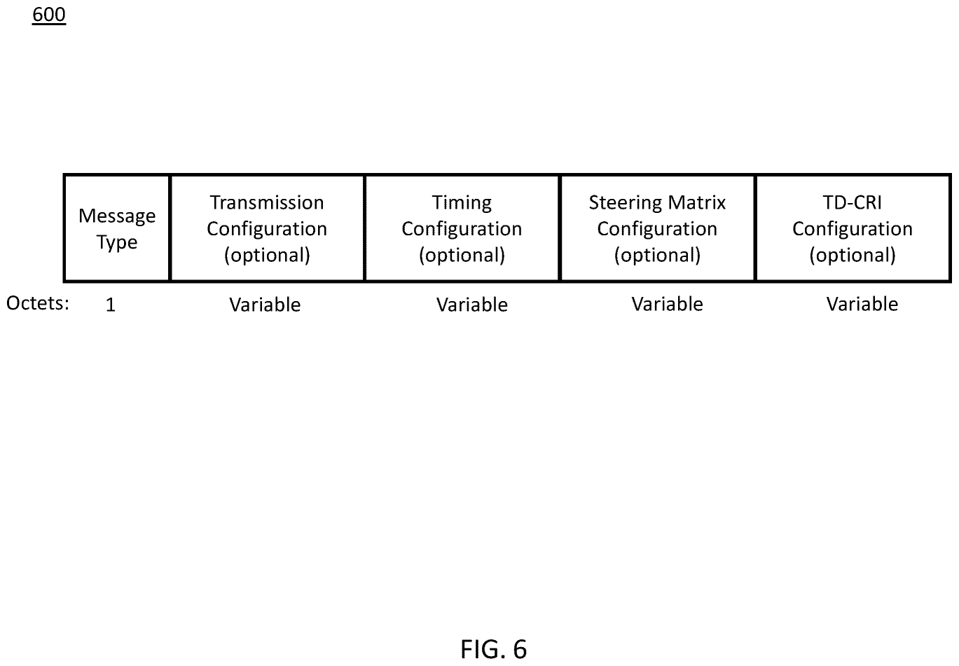

Some embodiments of the present disclosure as described above define sensing message types for Wi-Fi sensing, namely, sensing configuration message and sensing configuration response message. In an example, the sensing configuration message and the sensing configuration response message are carried in a new extension to a management frame of a type described in IEEE 802.11. FIG. 6 illustrates example of a component of a management frame 600 carrying a sensing transmission. In an example, system 500 may require acknowledgement frames and the management frame carrying sensing messages may be implemented as an Action frame and in another example, system 500 may not require acknowledgement frames and the management frame carrying sensing messages may be implemented as an Action No Ack frame.

In an implementation, the information content of all sensing message types may be carried in a format as shown in FIG. 6. In some examples, Transmission Configuration, Timing Configuration, Steering Matrix Configuration, and TD-CRI configuration as described in FIG. 6 are implemented as IEEE 802.11 elements. In some examples, the TD-CRI Configuration element is a part of the Transmission Configuration element.

In one or more embodiments, the sensing message types may be identified by the message type field, and each sensing message type may carry the other identified elements, according to some embodiments. In an example, the data may be encoded into an element for inclusion in sensing messages between sensing receiver 502, sensing transmitter 504, and sensing device 506. In a measurement campaign involving multiple sensing receivers and multiple sensing transmitters, these parameters may be defined for all sensing receivers-sensing transmitters pairs. In an example, when these parameters are transmitted from sensing device 506 to sensing receiver 502, then these parameters configure sensing receiver 502 to process a sensing transmission and calculate sensing measurements. In some examples, when these parameters are transmitted from sensing receiver 502 to sensing device 506, then these parameters report the configuration used by sensing receiver 502.

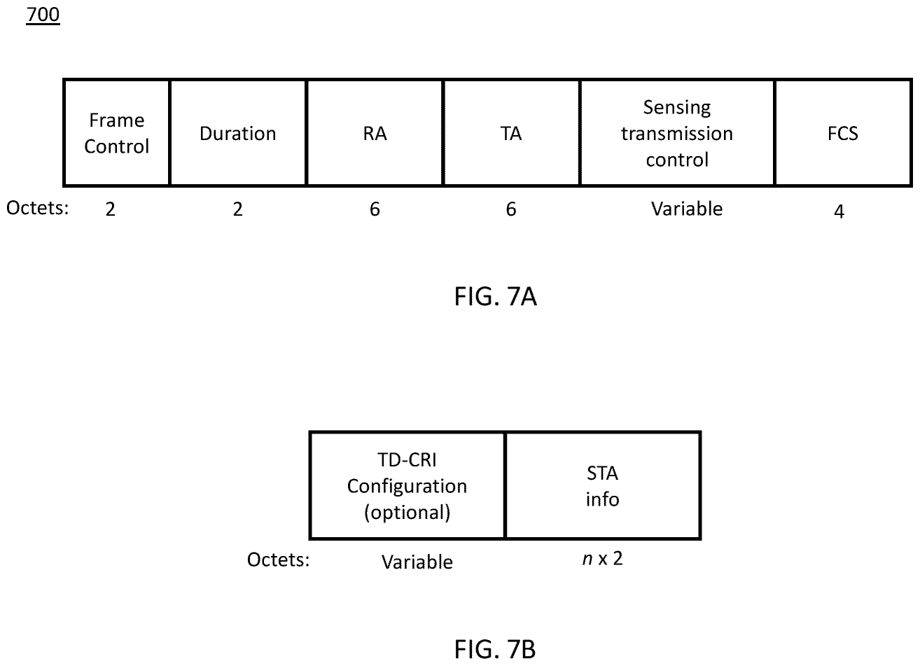

According to some implementations, a sensing transmission announcement may be carried in a new extension to a control frame of a type described in IEEE 802.11. In some implementations, the sensing transmission announcement may be carried in a new extension to a control frame extension described in IEEE 802.11. FIG. 7A illustrates an example of a format of control frame 700 and FIG. 7B illustrates a format of a sensing transmission control field of control frame 700. In an example, the STA info field of the sensing transmission control field may address up to n sensing receivers via their association ID (AID). In an example implementation, the sensing transmission announcement may address n sensing receivers that are required to make a sensing measurement and to relay channel representation information back to the sensing initiator.

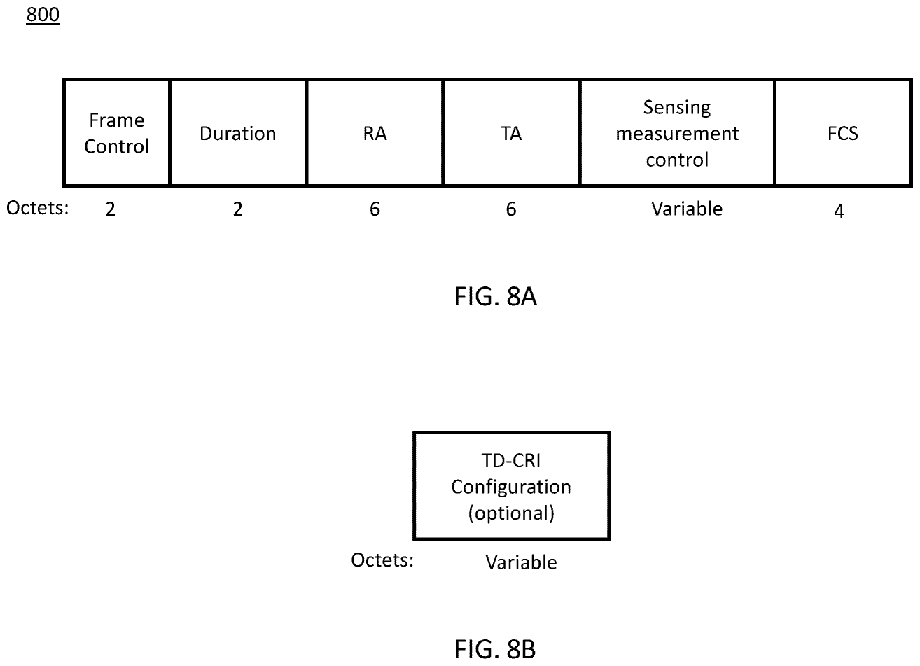

According to some implementations, the sensing measurement poll may be carried in a new extension to a control frame of a type described in IEEE 802.11. In some implementations, the sensing measurement poll may be carried in a new extension to a control frame extension described in IEEE 802.11. FIG. 8A illustrates an example of a format of control frame 800 and FIG. 8B illustrates a format of a sensing measurement control field of control frame 800.

According to some implementations, when sensing receiver 502 has calculated sensing measurements and created channel representation information (for example, in form of TD-CRI), the sensing receiver 502 may be required to communicate the channel representation information to sensing transmitter 504 or sensing device 506. In an example, the TD-CRI may be transferred by a management frame. In an example, a message type may be defined, which represents a CRI transmission message.

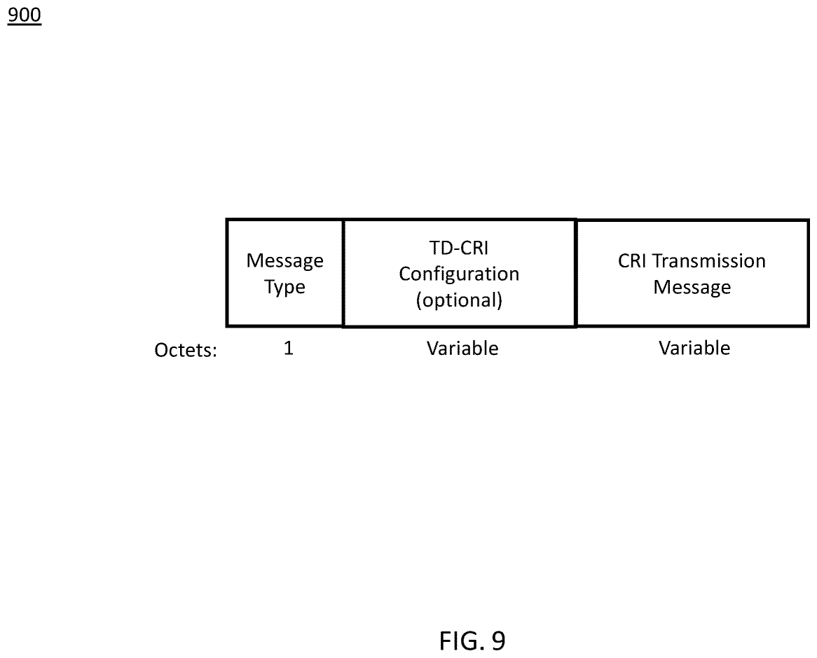

FIG. 9 illustrates an example of a component of a management frame 900 carrying a CRI transmission message, according to some embodiments. In an example, system 500 may require acknowledgement frames and the management frame carrying the CRI transmission message may be implemented as an Action frame, and in another example, system 500 may not require acknowledgement frames and the management frame carrying the CRI transmission message may be implemented as an Action No Ack frame.

In an implementation, when sensing device 506 is implemented on a separate device (i.e., is not implemented within sensing receiver 502 or sensing transmitter 504), a management frame may not be necessary, and the TD-CRI may be encapsulated in a standard IEEE 802.11 data frame and transferred to sensing device 506. In an example, a proprietary header or descriptor may be added to the data structure to allow sensing device 506 to detect that the data structure is of the form of a CRI transmission message Element. In an example, data may be transferred in the format shown in FIG. 9 and sensing device 506 may be configured to interpret the Message Type value that represents a CRI transmission message Element.

### C. Methods and Systems for Detection of Channel Variations for Wi-Fi Sensing in Unobserved Bandwidth

The present disclosure generally relates to methods and systems for Wi-Fi sensing. In particular, the present disclosure relates to methods and systems for detection of channel variations for Wi-Fi sensing in unobserved bandwidth.

Referring to FIG. 5, according to one or more implementations, for the purpose of Wi-Fi sensing, sensing receiver 502, sensing transmitter 504 or sensing device 506 may initiate a measurement campaign (or a Wi-Fi sensing session). In the measurement campaign, exchange of transmissions between sensing receiver 502 and sensing transmitter 504 may occur. In an example, control of these transmissions may be by the MAC layer of the IEEE 802.11 stack.

According to an example implementation, sensing receiver 502, sensing transmitter 504 or sensing device 506 may initiate the measurement campaign via one or more sensing trigger messages. In an implementation, sensing agent 516 or sensing agent 536 may be configured to generate a sensing trigger message configured to trigger a first sensing transmission from sensing transmitter 504. In an example, the sensing trigger message may include a requested transmission configuration field. Other examples of information/data included in the sensing trigger message that are not discussed here are contemplated herein. According to an implementation, sensing agent 516 or sensing agent 536 may transmit the sensing trigger message to sensing transmitter 504. In an implementation, sensing agent 516 or sensing agent 536 may transmit the sensing trigger message to sensing transmitter 504 via transmitting antenna 512 or transmitting antenna 532 to trigger the sensing transmission from sensing transmitter 504.

Sensing transmitter 504 may be configured to receive the sensing trigger message from sensing receiver 502 or sensing device 506 via receiving antenna 524. In response to receiving the sensing trigger message, sensing transmitter 504 may generate a first sensing transmission. In an example, the first sensing transmission that the sensing trigger message triggers from sensing transmitter 504 may be a sensing response message. In an implementation, sensing transmitter 504 may generate the first sensing transmission using the requested transmission configuration. In an implementation, sensing transmitter 504 may transmit the first sensing transmission to sensing receiver 502 in response to the sensing trigger message and in accordance with the requested transmission configuration. In an example, the first sensing transmission may include a delivered transmission configuration corresponding to the transmission configuration used to deliver the sensing transmission. In an example, when it may be supported by sensing transmitter 504, the delivered transmission configuration corresponds to the requested transmission configuration. In an implementation, the sensing transmitter 504 may transmit the first sensing transmission on a first transmission channel. Sensing transmitter 504 may transmit the first sensing transmission to sensing receiver 502 via transmitting antenna 522.

In an implementation, sensing receiver 502 may receive the first sensing transmission from sensing transmitter 504 transmitted in response to the sensing trigger message. Sensing receiver 502 may be configured to receive the first sensing transmission from sensing transmitter 504 via receiving antenna 514. According to an implementation, sensing agent 516 may be configured to generate a first sensing measurement based on the first sensing transmission received from sensing transmitter 504. The first sensing measurement may represent a first channel state information (CSI) of the first transmission channel. According to an implementation, sensing agent 516 may transmit the first CSI of the first transmission channel representing the first sensing measurement to sensing device 506 or sensing transmitter 504. In an implementation, sensing agent 516 may communicate the first CSI to sensing device 506 or sensing transmitter 504 via a first channel representation information (CRI) transmission message. According to an implementation, sensing agent 516 may transmit the first CRI transmission message to sensing device 506 or sensing transmitter 504 via transmitting antenna 512.

In the time domain, a transmission channel may be referred to as h(t). The transmission channel may also be described as an impulse response of the transmission channel. The impulse response of the transmission channel may include a plurality of time domain pulses. The plurality of time domain pulses may represent reflections that transmitted signals (for example, those transmitted by a transmitter) underwent before reaching a receiver. A reflected time domain pulse may be represented as:

$$h ( {t}_{k} ) = {α}_{k} δ ( t - {t}_{k} ) \qquad ( 8 )$$

where, tₖ represents a time delay of when the reflected time domain pulse reached the receiver in comparison to a line of sight pulse which was not reflected and ax is a complex value that represents frequency independent attenuation and phase of the received time domain pulse.

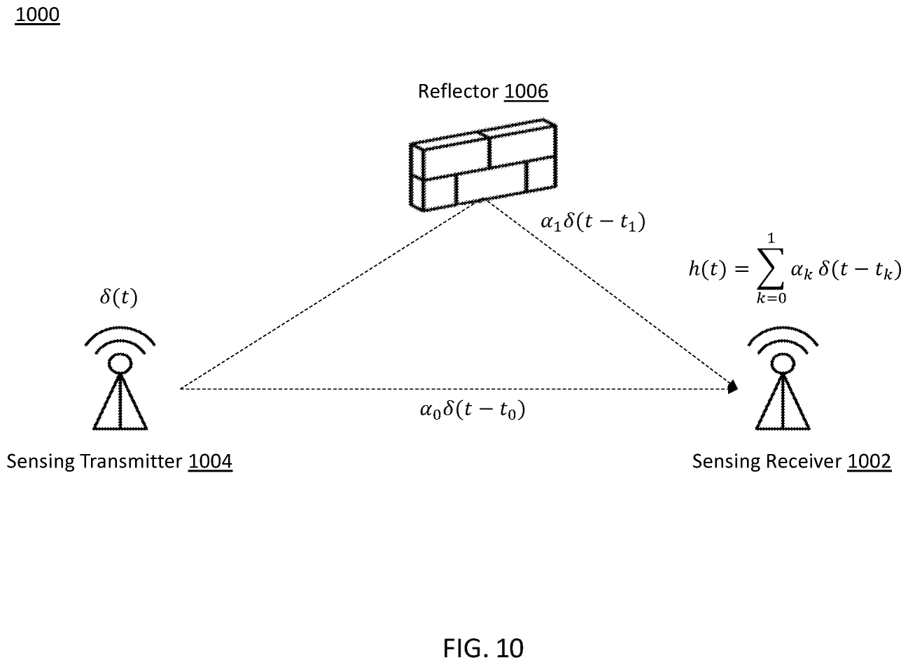

FIG. 10 depicts example representation 1000 of an over-the-air transmission channel, which includes a direct signal path and a single multipath, according to some embodiments. In an implementation, FIG. 10 depicts discrete multipaths of a time domain pulse δ(t) between sensing transmitter 1004 and sensing receiver 1002 according to some embodiments. In FIG. 10, a direct path signal is represented as:

$$h ( {t}_{0} ) = {α}_{0} δ ( t - {t}_{0} ) \qquad ( 9 )$$

and a first reflected time domain pulse is represented as:

$$h ( {t}_{1} ) = {α}_{1} δ ( t - {t}_{1} ) \qquad ( 10 )$$

The time domain pulse δ(t) undergoes a single reflection in addition to its line of sight path. The line of sight signal component transmission time may be incorporated into the complex coefficient do (i.e., t₀=0). The reflected time domain pulse may experience a delay of t₁ which represents the amount of time after the line of sight pulse is received that the reflected time domain pulse is received.

In an implementation, if a number of discrete multipaths are given by Lₚ, then the received time domain pulse may be represented as:

$$h ( t ) = {\sum }_{k = 0}^{{L}_{p}} {α}_{k} δ ( t - {t}_{k} ) \qquad ( 11 )$$

The Equation (11) indicates that the transmission channel includes a number of time domain pulses each of which may experience a different time delay. A time domain pulse from amongst the time domain pulses may be determined to be a line of sight time domain pulse. Further, each time domain pulse may have a frequency independent amplitude and phase component (referred to as the complex coefficient) and the line of sight time domain pulse may experience a time delay due to reflections, which contributes a frequency dependent component to the complex coefficient.

The received time domain signal h(t) of the Equation (11) may be converted to a frequency domain representation using a Fourier transform (for example, discrete Fourier transform (DFT) or fast Fourier transform (FFT)). The frequency domain representation of the received time domain signal h(t) may be a frequency response of the transmission channel or the CSI. In an example, the frequency domain representation of the received time domain signal h(t) may be given by Equation (12):

$$H ( f ) = {\sum }_{k = 0}^{{L}_{p}} {α}_{k} {e}^{- j 2 π {ft}_{k}} \qquad ( 12 )$$

In an implementation, when a Fourier transform is applied to a time domain signal, each time domain pulse of the Equation (11) may become an exponential term. The H(f) in Equation (12) is a continuous function and may give the theoretical frequency response of the transmission channel over all frequencies. In an example, any frequency domain representation of a transmission channel can be written as a sum of exponentials, where αₖ is the complex coefficient of exponential k. In the Equation (12), tₖ is multiplied by f, which means that the impact of the delay tₖ on the phase of the exponential term for the k^{th} pulse may be different at different frequencies. As a result, the actual phase of the exponential captured in αₖ may continuously be modulated by the reflected pulse in a manner which depends on the frequency of observation. At each frequency, the modulation is constant and deterministic. Where the received signal includes more than one reflection, each reflection contributes to the complex coefficient at frequency f. Further, the number of exponentials in the Equation (12) may be equal to the number of reflected time domain pulses at the receiver. In a practical scenario, there are typically only a few large reflections. Other observed time domain pulses are typically side-lobes of the larger reflections.

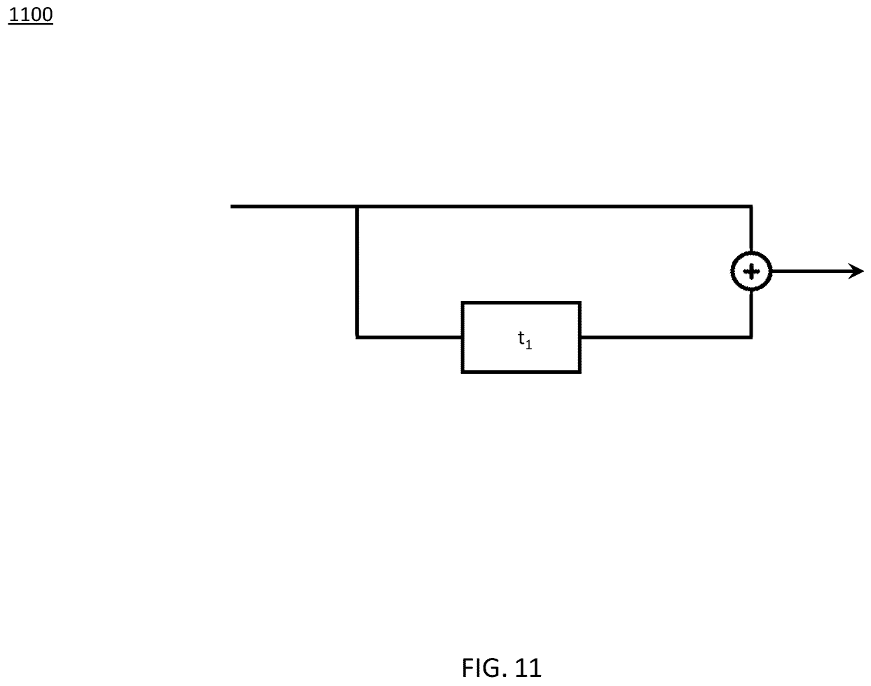

FIG. 11 depicts example representation 1100 of a transmission channel, which includes a received time domain signal with a single reflected path, according to some embodiments. In case of only one reflection, there are two time domain pulses in total. One is the line of sight time domain pulse and the other is the reflected time domain pulse. The time domain representation of the received time domain signal having a single reflected path is given in by Equation (13).

$$h ( t ) = {α}_{0} δ ( t ) + {α}_{1} δ ( t - {t}_{1} ) \qquad ( 13 )$$

In an example, the frequency domain representation of the received time domain signal h(t) may be given by Equation (14):

$$H ( f ) = {α}_{0} + {α}_{1} {e}^{- j 2 {π ft}_{1}} \qquad ( 14 )$$

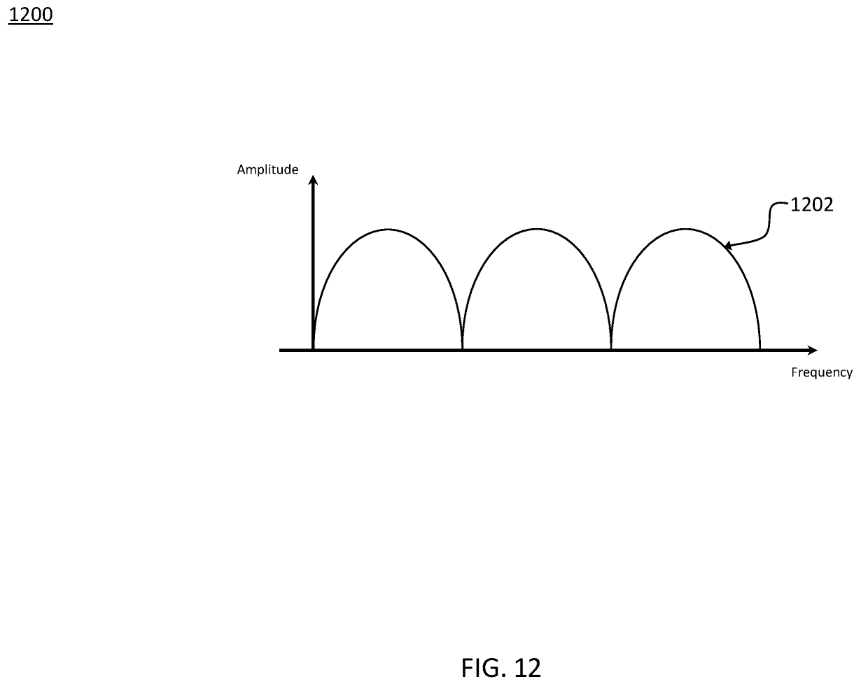

There are no limits on f which is a continuous time variable. In an example, Equation (14) does not incorporate any receiver or transmitter processing or sampling. Example frequency domain representation 1200 of the received time domain signal with a single reflected path is illustrated in FIG. 12. The phase of the reflected path is a function of ft₁. At some values of f, the phase of the reflection may be 180 degrees or half a wavelength off the phase of the line of sight time domain pulse. As a result, there may be destructive interference between the line of sight time domain pulse and the reflected time domain pulse. In example, when a Laplace transfer function is applied to H(f), the amplitude (magnitude) of the frequency domain signal may demonstrate a comb-like response (represented by reference number “1202”) as shown in FIG. 12. This phenomenon may continue to repeat indefinitely. The width of the lobe of the comb is determined by t₁.

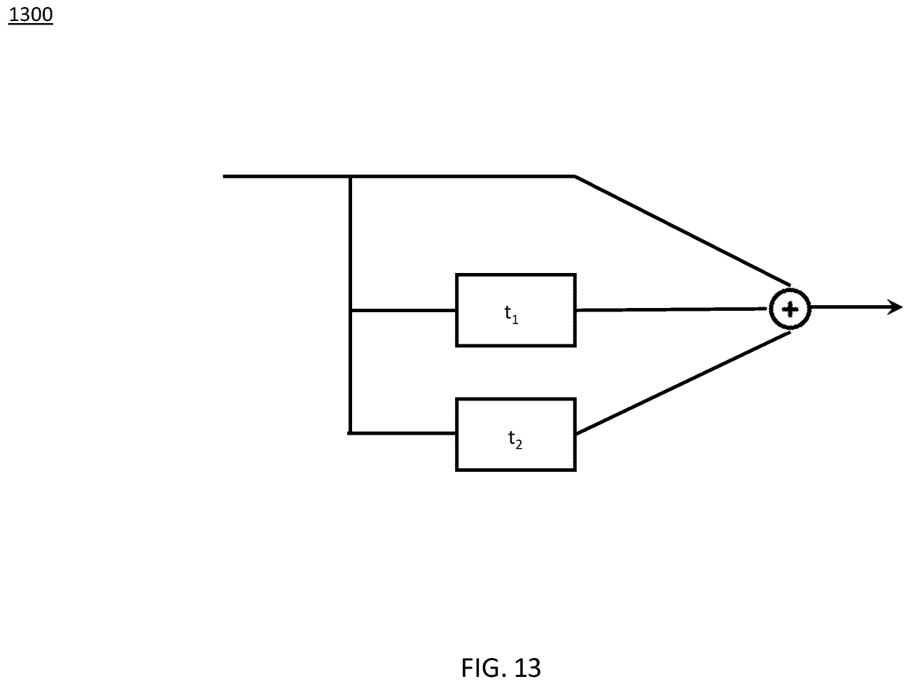

FIG. 13 depicts example representation 1300 of a transmission channel, which includes a received time domain signal with a two reflected paths, according to some embodiments. In case of multiple reflections, as shown in FIG. 13, there are three time domain pulses in total. One is the line of sight time domain pulse and the other two are the first reflected time domain pulse and the second reflected time domain pulse. The time domain representation of the received time domain signal having two reflected paths is given by Equation (15).

$$h ( t ) = {α}_{0} δ ( t ) + {α}_{1} δ ( t - {t}_{1} ) + {α}_{2} δ ( t - {t}_{2} ) \qquad ( 15 )$$

In an example, the frequency domain representation of the received time domain signal h(t) may be given by Equation (16):

$$H ( f ) = {α}_{0} + {α}_{1} {e}^{- j 2 {π ft}_{1}} + {α}_{2} {e}^{- j 2 {π ft}_{2}} \qquad ( 16 )$$

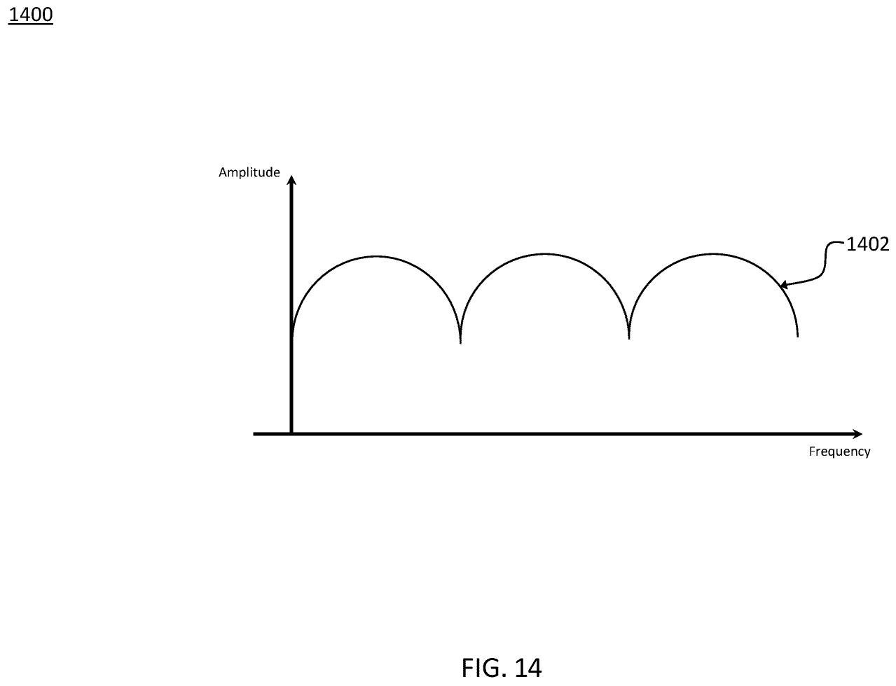

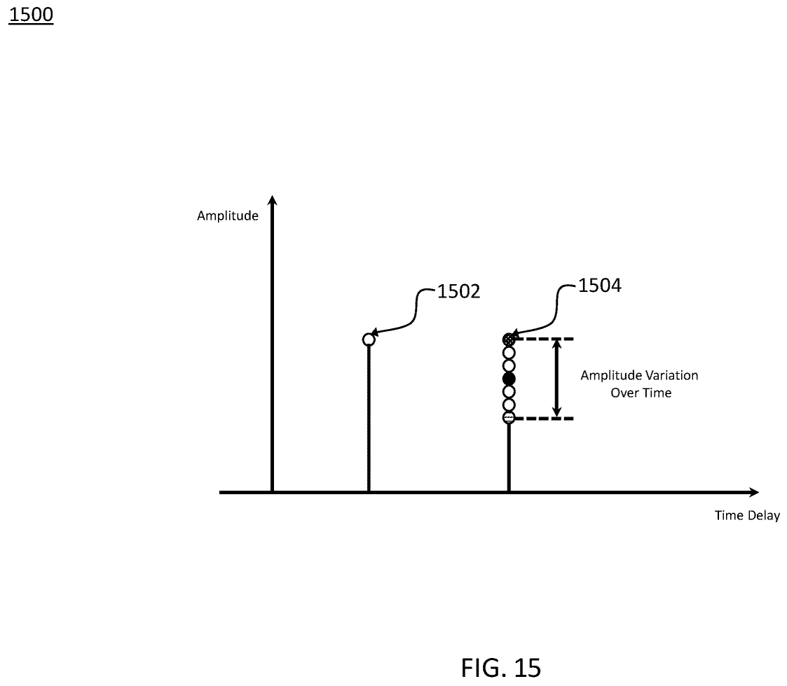

As with the single reflection case, there are no limits on f which is a continuous time variable. In examples, Equation (16) does not incorporate any receiver or transmitter processing or sampling. Example frequency domain representation 1400 of the received time domain signal with two reflected paths is illustrated in FIG. 14. The phase of the first reflected time domain pulse is a function of ft₁ and the phase of the second reflected time domain pulse is a function of ft₂. At each value of f, the phases of the line of sight time domain pulse, the first reflected time domain pulse, and the second reflected time domain pulse may combine which may cause some degree of destructive interference to the line of sight time domain pulse. Similar to the single reflected signal case, applying a Laplace transfer function to H(f) may result in the amplitude (magnitude) of the frequency domain signal to demonstrate the comb-like response (represented by reference number “1402”) as shown in FIG. 14. This phenomenon may continue to repeat indefinitely. The width of the lobe of the comb is determined by a combination of t₁ and t₂, and the pattern of the comb may still be periodic.

According to an implementation, in a Wi-Fi sensing system, reflections are due to a physical process in a transmission channel. Accordingly, the reflections caused by the physical process may change according to the physical process. The physical process in the transmission channel may cause a variation in an amplitude of a received time domain signal. In some situations, the physical process in the transmission channel may also cause a variation in time delay of the received time domain signal. Example time domain representation 1500 of a received time domain signal with a single reflected path modulated by a physical process including amplitude variations is shown in FIG. 15. FIG. 15 describes a line of sight time domain pulse (represented by reference number “1502”) and a reflected time domain pulse (represented by reference number “1504”). Further, as described in FIG. 15, the amplitude of the complex coefficient of the reflected time domain pulse varies over time due to the movement caused by the physical process.

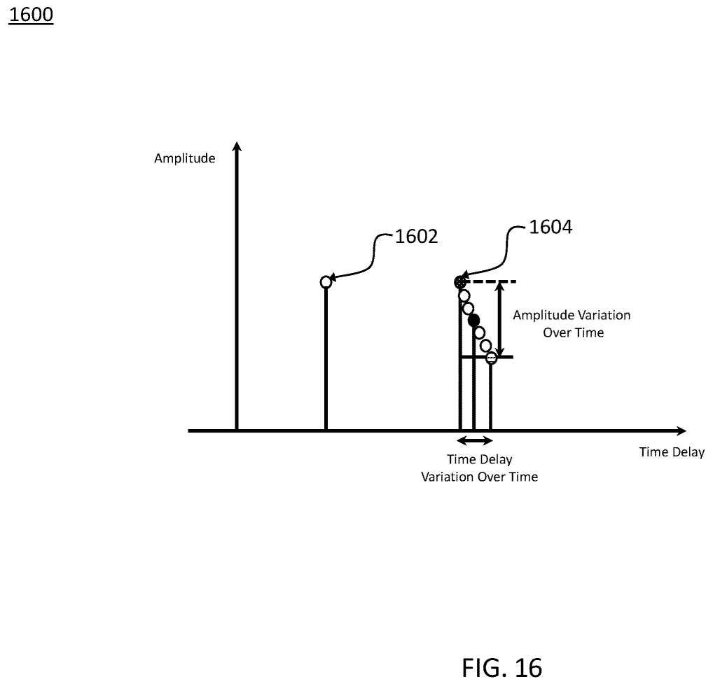

Example time domain representation 1600 of a received time domain signal with a single reflected path modulated by a physical process including amplitude variations and time delay variations is shown in FIG. 16. FIG. 16 describes a line of sight time domain pulse (represented by reference number “1602”) and a reflected time domain pulse (represented by reference number “1604”). Further, as described in FIG. 16, the amplitude of the complex coefficient of the reflected time domain pulse varies over time due to the movement caused by the physical process. Also, the physical process causes a variation in the time delay of the reflected time domain pulse. For ease of explanation and understanding, the remainder of the description provided in the present disclosure is based on the assumption that the time delay of reflected time domain pulses remains constant and only the amplitude of the complex coefficient of the reflected time domain pulses varies, however with no loss of generality of the present disclosure, the reflected time domain pulses may have variable amplitude, variable time delays, or both.

As described earlier, sensing agent 516 receives the first CSI of the first transmission channel representing the first sensing measurement performed on a first sensing transmission transmitted from sensing transmitter 504 to sensing receiver 502 in the first transmission channel. In an example, for a 20 MHz bandwidth transmission channel, sensing agent 516 will receive CSI for the 20 MHz bandwidth transmission channel. Sensing agent 516 on sensing receiver 502 may send the received CSI for the 20 MHz bandwidth transmission channel to sensing transmitter 504 or sensing device 506 for further processing. The bandwidth transmission channel may be any supported bandwidth and may for example be a 20 MHz bandwidth transmission channel, a 40 MHz bandwidth transmission channel, an 80 MHz bandwidth transmission channel, an 80+80 MHz bandwidth transmission channel, or a 160 MHz bandwidth transmission channel.

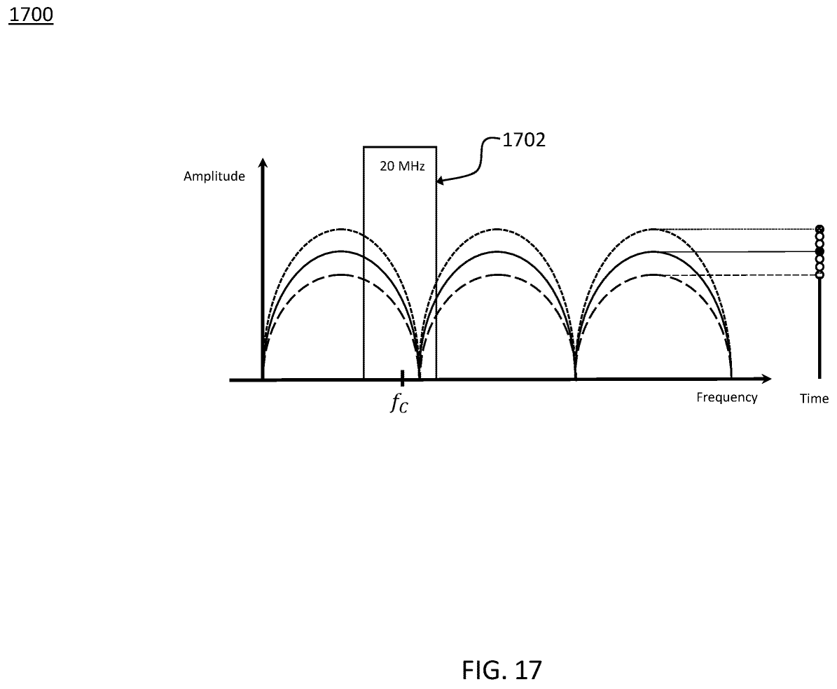

FIG. 17 depicts example frequency domain representation 1700 of a received time domain signal with a single reflected path modulated by a physical process including amplitude variations showing a 20 MHz bandwidth transmission channel, according to some embodiments. As described in FIG. 17, the 20 MHz bandwidth transmission channel (represented by reference number “1702”) is centered at fc. The reflected path may include two time domain pulses. One is the line of sight time domain pulse and the other is the reflected time domain pulse. In an implementation, the 20 MHz bandwidth transmission channel received by sensing receiver 502 captures an area where the reflected time domain pulse causes destructive interference with the line of sight time domain pulse, which in turn compresses the amplitude variations caused by the modulation of the reflected time domain pulse due to the physical process. This amplitude compression reduces the signal-to-noise ratio (SNR) of the sensing measurement which may result in an inaccurate detection of the physical process.

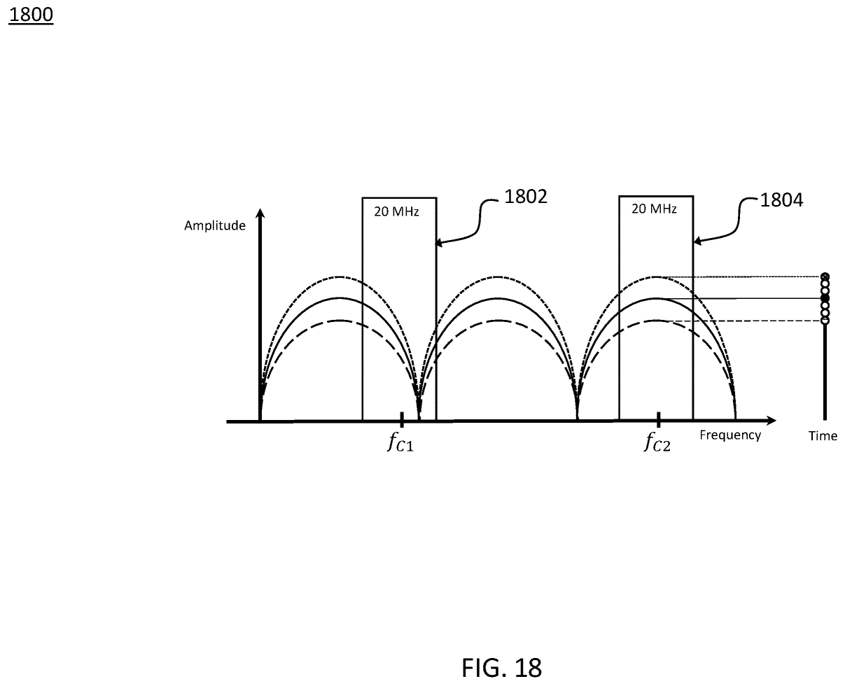

FIG. 18 depicts example frequency domain representation 1800 of a received time domain signal with a single reflected path modulated by a physical process including amplitude variations showing two 20 MHz bandwidth transmission channels, according to some embodiments. FIG. 18 illustrates two different 20 MHz bandwidth transmission channels across the same frequency representation of the transmission channel, where one 20 MHz bandwidth transmission channel (represented by reference number “1802”) is centered at f_{C1} and another 20 MHz bandwidth transmission channel (represented by reference number “1804”) is centered at f_{C2}. The 20 MHz bandwidth transmission channel centered at f_{C1} captures a portion of the frequency band which includes destructive interference (as described in FIG. 17) and the 20 MHz bandwidth transmission channel centered at f_{C2} captures a portion of the frequency band where the reflected time domain pulse constructively combines with the line of sight time domain pulse. This may result in expansion of the amplitude variations caused by the modulation of the reflected time domain pulse due to the physical process. In an implementation, the amplitude expansion increases the SNR of the sensing measurement which may result in an accurate detection of the physical process. Accordingly, it may be advantageous for sensing receiver 502 to make sensing measurements on the 20 MHz sensing transmission centered at f_{C2} instead of on the 20 MHz sensing transmission centered at f_{C1}. The manner in which a range of frequencies may be determined for making sensing measurements in order to accurately detect the physical process is described hereinafter.

Referring back to FIG. 5, according to an implementation, upon receiving the first CSI of the first transmission channel representing the first sensing measurement performed on the first sensing transmission transmitted from sensing transmitter 504 to sensing receiver 502 in the first transmission channel, sensing agent 516 may calculate a time-domain channel representation (TD-CRI) of the first CSI by transforming the first CSI into the time domain. In an example, sensing receiver 502 may send the first CSI of the first transmission channel to sensing transmitter 504, in which case sensing agent 526 may calculate a time-domain channel representation (TD-CRI) of the first CSI by transforming the first CSI into the time domain. In an example, sensing receiver 502 may send the first CSI of the first transmission channel to sensing device 506, in which case sensing agent 536 may calculate a time-domain channel representation (TD-CRI) of the first CSI by transforming the first CSI into the time domain. The description that follows is explained in relation to sensing agent 536 of sensing device 506 performing the processing steps, however it should be understood with no loss of generality that the processing steps may be performed in some examples by sensing agent 516 on sensing receiver 502 or by sensing agent 526 on sensing transmitter 504.

In an example, the TD-CRI may be a full TD-CRI or a filtered CRI. In an implementation, sensing agent 536 may calculate the TD-CRI from the first CSI by performing an inverse discrete Fourier transform (IDFT) on the first CSI, converting from the frequency domain to the time domain. The frequency domain CSI, H(f), can be represented as time domain pulses referred to as TD-CRI. In an implementation, when the TD-CRI is calculated by taking the IDFT of the CSI, H(f), there is a one-to-one correspondence between a frequency domain tone (a complex value of the first CSI) and a time domain tone (complex value of the TD-CRI), and it is referred to as full TD-CRI. The full TD-CRI and CSI may form a pair of discrete Fourier transforms (DFT). In an example, by considering full TD-CRI as a time-domain sequence and CSI as a frequency-domain sequence, the full TD-CRI can be derived as the IDFT of the CSI and the CSI may be reconstructed as the DFT of the full TD-CRI. In an implementation, the processing of DFT and IDFT may be implemented using FFT and IFFT, respectively.

In an implementation, the TD-CRI may include the same information of the channel representation as the CSI. However, this information is typically concentrated in only a few time domain pulses. In examples, if the time domain pulses that don't carry information are not considered, this means that the CRI can be represented with fewer data by only considering the time domain pulses that are needed. Such CRI may be referred to as filtered TD-CRI. In an implementation, the filtered TD-CRI may be expressed in form of Equation (11), that is h(t)=Σₖ₌₀^{L}^{ₚ}αₖδ(t−tₖ).

According to an implementation, sensing agent 536 may generate a plurality of estimated channel responses corresponding to a plurality of transmission channels according to the TD-CRI. The manner in which sensing agent 536 generates the plurality of estimated channel responses corresponding to the plurality of transmission channels is described below.

In an implementation, sensing agent 536 may extract complex coefficients and time delays of pulses defined by the TD-CRI. In an example implementation, in case the TD-CRI is filtered TD-CRI, sensing agent 536 may extract the complex coefficients αₖ and the time delays tₖ of the pulses defined by the filtered TD-CRI as expressed in Equation (11). Further, sensing agent 536 may calculate a frequency domain representation of one or more frequency bands according to the complex coefficients and the time delays. In an implementation, sensing agent 536 may input the complex coefficients αₖ and the time delays tₖ into the frequency domain representation of the first transmission channel in the form of Equation (12), that is H(f)=Σₖ₌₀^{L}^{ₚ}αₖe^{-j2πft}^{ₖ}. In an implementation, sensing agent 536 may calculate the frequency domain representation using the input complex coefficients and the time delays.

According to an implementation, sensing agent 536 may calculate each of the plurality of estimated channel responses as a response to a frequency of each of the plurality of transmission channels in the one or more frequency bands according to the frequency domain representation of the sensing space determined complex coefficients αₖ and the time delays tₖ into the frequency domain representation of the first transmission channel in the form of Equation (12). The frequency of each of the plurality of transmission channels may represent a tunable frequency of sensing transmitter 504 or a range of tunable frequencies of sensing transmitter 504. In an example, sensing agent 536 may calculate each of the plurality of estimated channel responses at one or more frequencies in 2.4 GHz frequency band. In another example, sensing agent 536 may calculate each of the plurality of estimated channel responses at one or more frequencies in 5.8 GHz frequency band.

In an implementation, sensing agent 536 may calculate magnitudes of the plurality of estimated channel responses. In an example implementation, sensing agent 536 may calculate the magnitudes using a Laplace transform. Other examples of techniques/methods for calculation of the magnitudes of the plurality of estimated channel responses that are not discussed here are contemplated herein. According to an implementation, sensing agent 536 may then sort the magnitudes of the plurality of estimated channel responses.

According to an implementation, sensing agent 536 may determine one or more preferred transmission channels from among the plurality of transmission channels according to the plurality of estimated channel responses. In an implementation, sensing agent 536 may determine a preferential order of the plurality of transmission channels according to sorted magnitudes of corresponding ones of the plurality of estimated channel responses. In an implementation, sensing agent 536 may determine the one or more preferred transmission channels based on eliminating transmission channels having a magnitude of a corresponding estimated channel response below a magnitude floor. Accordingly, only those transmission channels that have a magnitude above a magnitude floor are taken into consideration for determining the one or more preferred transmission channels.

In an implementation, sensing agent 536 may determine the one or more preferred transmission channels based on determining a preferential order of sensing channel frequencies according to a mapping between the plurality of transmission channels and tunable frequencies of sensing transmitter 504. The preferential order of the plurality of transmission channels and the preferential order of sensing channel frequencies may be used for making sensing transmissions and/or sensing measurements in order to accurately detect the physical process. In an example, the preferential order of sensing channel frequencies may include optimum sensing channel frequencies and the preferential order of the plurality of transmission channels may include optimum transmission channels for making sensing transmissions and/or sensing measurements.

According to an implementation, sensing agent 536 may receive one or more input parameters. In an example, sensing agent 536 may receive the one or more input parameters from a sensing algorithm running at the application layer in sensing device 506. Input parameters may include information which influences the selection of a transmission channel for a sensing transmission. Examples of input parameters include information related to channels for which there is Clear Channel Access (CCA), the required channel bandwidth for the transmission, the available transmission power, the available antenna ports, or antenna gain, supported frequency channels, or whether the transmitter has a preference for a 2.4 GHz or 5 GHz frequency band. According to an implementation, sensing agent 536 may select one or more preferred transmission channels according to the preferential order of the plurality of transmission channels and the one or more input parameters. In some implementations, sensing agent 536 may select the one or more preferred transmission channels according to the preferential order of sensing channel frequencies and the one or more input parameters. In an implementation, the time constant for the physical process is significantly longer than the symbol time. The time constant may provide a significant number of symbols using which sensing agent 536 may determine the preferential sensing channel frequencies and the preferential transmission channels. In an example implementation, sensing agent 536 may determine the optimum sensing channel frequencies to make sensing transmissions and/or sensing measurements such that the sensing measurements can be used to detect and measure the physical process taking place in the transmission channel with the highest SNR.

According to an implementation, once sensing agent 536 determines the one or more preferred transmission channels from among the plurality of transmission channels according to the plurality of estimated channel responses that are likely to have a high SNR with respect to the physical process, sensing agent 536 may perform several actions to improve the precision of sensing measurements for more accurate detection of the physical process.

In an implementation, if the preferential sensing channel frequencies are absolute frequencies, sensing agent 536 may convert the preferential sensing channel frequencies to tunable center frequencies for use in the Wi-Fi sensing. In some embodiments, sensing agent 536 may convert the preferential sensing channel frequencies to channel numbers. Further, in some embodiments, sensing agent 536 may convert the preferential sensing channel frequencies to transmission channel identifiers.

According to an implementation, sensing agent 536 may use the information about the preferential sensing channel frequencies to instruct or cause sensing transmitter 504 and sensing receiver 502 to send sensing transmissions and make sensing measurements, respectively, at the preferential sensing channel frequencies to detect and measure the physical process in the sensing space. In an implementation, sensing agent 536 may use the information about the preferential sensing channel frequencies to determine the frequencies at which sensing transmitter 504 and/or sensing receiver 502 will operate. In an example implementation, sensing agent 536 may select one of the one or more preferred transmission channels. According to an implementation, sensing agent 536 may cause sensing receiver 502 to tune to the selected one of the one or more preferred transmission channels. In an implementation, sensing agent 536 may cause sensing receiver 502 to tune to the selected one of the one or more preferred transmission channels to enable sensing receiver 502 to make an opportunistic sensing measurement. The opportunistic sensing measurement may be understood as a sensing measurement made on a signal (for example, a data signal, an NDP, or a sensing transmission) being transmitted on the selected one of the one or more preferred transmission channels by sensing transmitter 504 (or any sensing transmitter). According to some implementations, sensing agent 536 may cause sensing receiver 502 to tune to the selected one of the one or more preferred transmission channels in order to make sensing measurements when sensing receiver 502 is in an idle mode. In such scenario, previous sensing configurations of sensing receiver 502 may be replaced with a new sensing configuration. The new sensing configuration may cause sensing receiver 502 to make sensing measurements on the selected one of the one or more preferred transmission channels.

In some implementations, sensing agent 536 may cause sensing receiver 502 to tune to a transmission channel according to the preferential order of the plurality of transmission channels. In an implementation, sensing agent 536 may provide information regarding the preferential order of the plurality of transmission channels to sensing receiver 502. In response to receiving the information about the preferential order of the plurality of transmission channels, sensing receiver 502 may select any transmission channel from the preferential list of transmission channels to make a sensing measurement. In some examples, sensing receiver 502 may select more than one transmission channel from the preferential list of transmission channels to make sensing measurements.

According to some implementations, sensing agent 536 may cause transmission of a sensing trigger message configured to trigger sensing transmitter 504 to make a second sensing transmission in the selected one of the one or more preferred transmission channels. According to an implementation, sensing agent 536 may instruct sensing transmitter 504 to transmit the second sensing transmission on a selected transmission channel. Further, sensing agent 536 may instruct sensing receiver 502 to receive the second sensing transmission on the selected transmission channel and perform a second sensing measurement. In an implementation, sensing transmitter 504 and sensing receiver 502 may be instructed to tune to the selected transmission channel when they are in an idle mode in order to send the second sensing transmission and make the second sensing measurement, respectively. In such scenario, previous sensing configurations of sensing transmitter 504 and sensing receiver 502 may be replaced with a new sensing configuration. The new sensing configuration may cause sensing transmitter 504 to transmit sensing transmissions and sensing receiver 502 to make sensing measurements on an optimum transmission channel.

In an implementation, sensing agent 536 may cause transmission of a sensing trigger message configured to trigger sensing transmitter 504 to make a second sensing transmission according to the preferential order of the plurality of transmission channels. According to an implementation, sensing agent 536 may select one of the one or more preferred transmission channels. Sensing agent 536 may cause transmission of the sensing trigger message configured to trigger sensing transmitter 504 to make the second sensing transmission according to the selected one of the one or more preferred transmission channels. In an implementation, sensing transmitter 504 may transmit the second sensing transmission to sensing receiver 502. Sensing receiver 502 may make or perform a second sensing measurement representing a second CSI on the second sensing transmission received from sensing transmitter 504. In an implementation, sensing receiver 502 may communicate the second CSI to sensing transmitter 504 or sensing device 506 via a second CRI transmission message.

According to an implementation, sensing agent 536 may provide information regarding the preferential order of the plurality of transmission channels to sensing receiver 502. In response to receiving the information regarding the preferential order of the plurality of transmission channels, sensing receiver 502 may select any transmission channel from the preferential order of the plurality of transmission channels to make a sensing measurement. In an implementation, sensing receiver 502 may send a sensing trigger message to sensing transmitter 504 in order to initiate a sensing transmission on the selected transmission channel. According to some implementations, sensing receiver 502 may select more than one transmission channel from the preferential order of the plurality of transmission channels. Accordingly, sensing receiver 502 may send sensing trigger messages to one or more sensing transmitters (at once or over a period of time) in order to initiate one or more sensing transmissions on the selected transmission channels. Sensing receiver 502 may then make sensing measurements on the one or more sensing transmissions.

According to an example implementation, sensing receiver 502 may send a sensing trigger messages to sensing transmitter 504 to make a third sensing transmission in non-preferred transmission channels. In an implementation, sensing transmitter 504 may transmit the third sensing transmission to sensing receiver 502. Sensing receiver 502 may make or perform a third sensing measurement representing a third CSI on the third sensing transmission received from sensing transmitter 504. In an implementation, sensing receiver 502 may communicate the third CSI to sensing transmitter 504 or sensing device 506 via a third CRI transmission message.

In an implementation, sensing transmitter 504 or sensing device 506 or sensing agent 536 may receive the second CSI of the selected one of the one or more preferred transmission channels representing the second sensing measurement performed on the second sensing transmission transmitted from sensing transmitter 504 to sensing receiver 502 in the selected one of the one or more preferred transmission channels. Further, sensing transmitter 504 or sensing device 506 or sensing agent 536 may receive the third CSI of the non-preferred transmission channels representing the third sensing measurement performed on the third sensing transmission transmitted from sensing transmitter 504 to sensing receiver 502 in the non-preferred transmission channels.

According to an implementation, sensing transmitter 504 or sensing device 506 or sensing agent 536 may prioritize second CSI determined based on second sensing measurements performed on second sensing transmissions in the one or more preferred transmission channels over third CSI determined based on third sensing measurements performed on third sensing transmissions in non-preferred transmission channels. According to an implementation, sensing transmitter 504 or sensing device 506 or sensing agent 536 may analyze the second CSI determined based on the second sensing measurements performed on the second sensing transmissions in the one or more preferred transmission channels while in a first mode. In an example, the first mode may be a detection mode. Further, sensing device 506 may analyze the third CSI determined based on the third sensing measurements performed on the third sensing transmissions in preferred and non-preferred transmission channels while in a second mode. In an example, the second mode may be a scanning mode.

According to aspects of the present disclosure, since the one or more effective or optimum frequencies at which to send sensing transmissions and make sensing measurements are determined, the physical process in the sensing space can be detected without having to physically measure the CSI at each frequency to determine the one or more effective or optimum frequencies. Accordingly, system 500 is aided to choose a frequency for making sensing transmissions and/or sensing measurements (or to provide an input to influence the frequency at which sensing transmissions and/or sensing measurements can be made) without having to tune sensing receiver 502 and/or sensing transmitter 504 to each transmission channel individually.

FIG. 19 depicts flowchart 1900 for determining preferred transmission channels from among a plurality of transmission channels, according to some embodiments.

In a brief overview of an implementation of flowchart 1900, at step 1902, a first CSI of a first transmission channel representing a first sensing measurement performed on a first sensing transmission transmitted from sensing transmitter 504 to sensing receiver 502 in the first transmission channel is received. At step 1904, a TD-CRI of the first CSI is calculated by transforming the first CSI into the time domain. At step 1906, a plurality of estimated channel responses corresponding to a plurality of transmission channels is generated according to the TD-CRI. At step 1908, preferred transmission channels from among the plurality of transmission channels are determined according to the plurality of estimated channel responses.

Step 1902 includes receiving a first CSI of a first transmission channel representing a first sensing measurement performed on a first sensing transmission transmitted from sensing transmitter 504 to sensing receiver 502 in the first transmission channel. According to an implementation, sensing agent 516 on sensing receiver 502, or sensing agent 526 on sensing transmitter 504 or sensing agent 536 on sensing device 506 may be configured to receive the first CSI of the first transmission channel representing the first sensing measurement performed on the first sensing transmission transmitted from sensing transmitter 504 to sensing receiver 502 in the first transmission channel.

Step 1904 includes calculating, based on the first CSI, a TD-CRI of the first CSI by transforming the first CSI into the time domain. According to an implementation, sensing agent 516 on sensing receiver 502, or sensing agent 526 on sensing transmitter 504 or sensing agent 536 on sensing device 506 may be configured to calculate the TD-CRI of the first CSI by transforming the first CSI into the time domain.

Step 1906 includes generating a plurality of estimated channel responses corresponding to a plurality of transmission channels according to the TD-CRI. According to an implementation, sensing agent 516 on sensing receiver 502, or sensing agent 526 on sensing transmitter 504 or sensing agent 536 on sensing device 506 may be configured to generate the plurality of estimated channel responses corresponding to the plurality of transmission channels according to the TD-CRI.

Step 1908 includes determining preferred transmission channels from among the plurality of transmission channels according to the plurality of estimated channel responses. According to an implementation, sensing agent 516 on sensing receiver 502, or sensing agent 526 on sensing transmitter 504 or sensing agent 536 on sensing device 506 may be configured to determine preferred transmission channels from among the plurality of transmission channels according to the plurality of estimated channel responses.

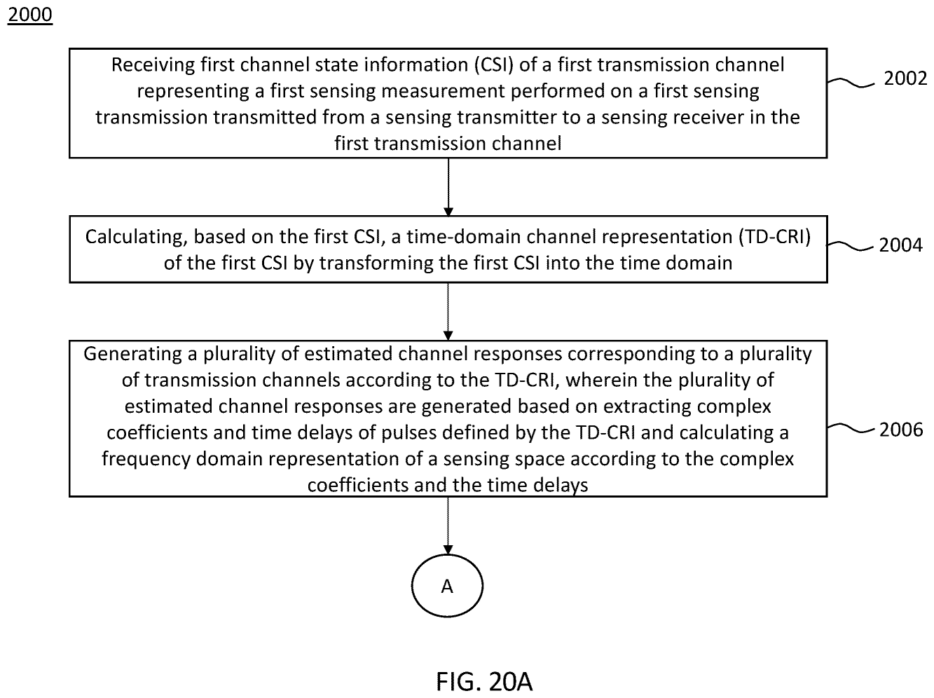

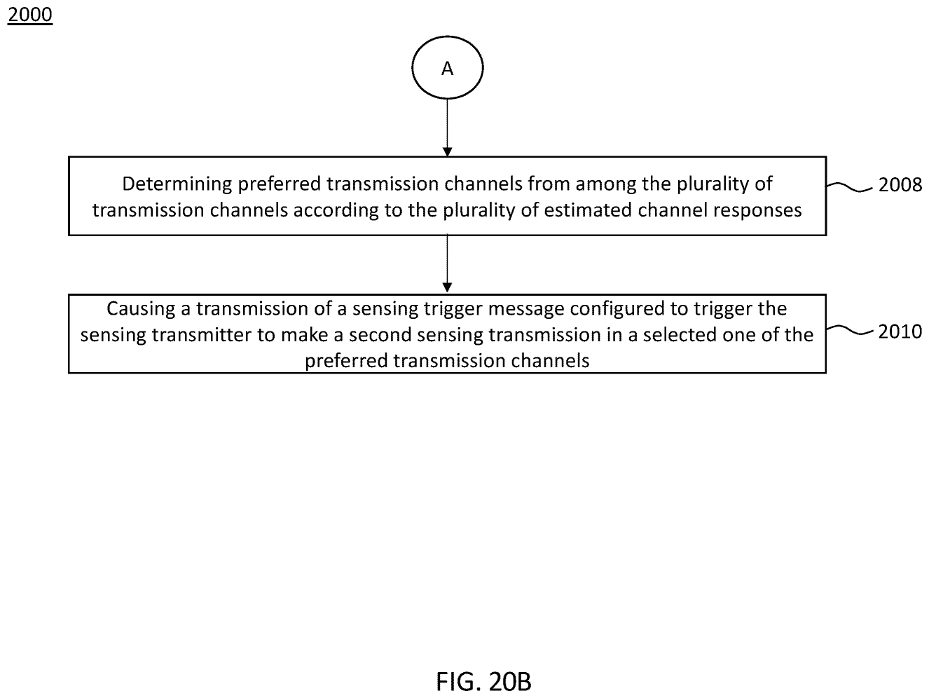

FIG. 20A and FIG. 20B depict flowchart 2000 for causing a transmission of a sensing trigger message configured to trigger sensing transmitter 504 to make a second sensing transmission in a selected one of preferred transmission channels, according to some embodiments.

In a brief overview of an implementation of flowchart 2000, at step 2002, a first CSI of a first transmission channel representing a first sensing measurement performed on a first sensing transmission transmitted from sensing transmitter 504 to sensing receiver 502 in the first transmission channel is received. At step 2004, a TD-CRI of the first CSI is calculated by transforming the first CSI into the time domain. At step 2006, a plurality of estimated channel responses corresponding to a plurality of transmission channels is generated according to the TD-CRI. The plurality of estimated channel responses may be generated based on extracting complex coefficients and time delays of pulses defined by the TD-CRI and calculating a frequency domain representation of a sensing space according to the complex coefficients and the time delays. At step 2008, preferred transmission channels from among the plurality of transmission channels are determined according to the plurality of estimated channel responses. At step 2010, a transmission of a sensing trigger message is caused to trigger sensing transmitter 504 to make a second sensing transmission in a selected one of the preferred transmission channels.

Step 2002 includes receiving a first CSI of a first transmission channel representing a first sensing measurement performed on a first sensing transmission transmitted from sensing transmitter 504 to sensing receiver 502 in the first transmission channel. According to an implementation, sensing agent 516 on sensing receiver 502, or sensing agent 526 on sensing transmitter 504 or sensing agent 536 on sensing device 506 may be configured to receive the first CSI of the first transmission channel representing the first sensing measurement performed on the first sensing transmission transmitted from sensing transmitter 504 to sensing receiver 502 in the first transmission channel.

Step 2004 includes calculating, based on the first CSI, a TD-CRI of the first CSI by transforming the first CSI into the time domain. According to an implementation, sensing agent 516 on sensing receiver 502, or sensing agent 526 on sensing transmitter 504 or sensing agent 536 on sensing device 506 may be configured to calculate the TD-CRI of the first CSI by transforming the first CSI into the time domain.

Step 2006 includes generating a plurality of estimated channel responses corresponding to a plurality of transmission channels according to the TD-CRI, wherein the plurality of estimated channel responses are generated based on extracting complex coefficients and time delays of pulses defined by the TD-CRI and calculating a frequency domain representation of a sensing space according to the complex coefficients and the time delays. According to an implementation, sensing agent 516 on sensing receiver 502, or sensing agent 526 on sensing transmitter 504 or sensing agent 536 on sensing device 506 may be configured to generate the plurality of estimated channel responses corresponding to the plurality of transmission channels according to the TD-CRI. In an implementation, sensing agent 516 on sensing receiver 502, or sensing agent 526 on sensing transmitter 504 or sensing agent 536 on sensing device 506 may generate the plurality of estimated channel responses based on extracting the complex coefficients and the time delays of pulses defined by the TD-CRI and calculating the frequency domain representation of the sensing space according to the complex coefficients and the time delays.

Step 2008 includes determining preferred transmission channels from among the plurality of transmission channels according to the plurality of estimated channel responses. According to an implementation, sensing agent 516 on sensing receiver 502, or sensing agent 526 on sensing transmitter 504 or sensing agent 536 on sensing device 506 may be configured to determine preferred transmission channels from among the plurality of transmission channels according to the plurality of estimated channel responses.

Step 2010 includes causing a transmission of a sensing trigger message configured to trigger sensing transmitter 504 to make a second sensing transmission in a selected one of the preferred transmission channels. According to an implementation, sensing agent 516 on sensing receiver 502, or sensing agent 526 on sensing transmitter 504 or sensing agent 536 on sensing device 506 may cause the transmission of the sensing trigger message configured to trigger sensing transmitter 504 to make the second sensing transmission in the selected one of the preferred transmission channels.

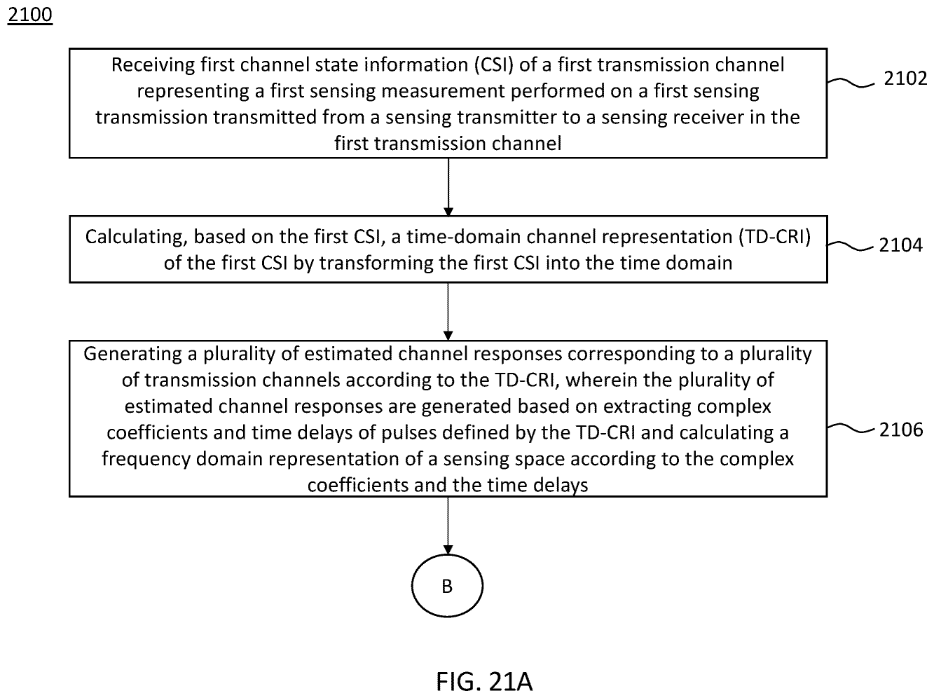

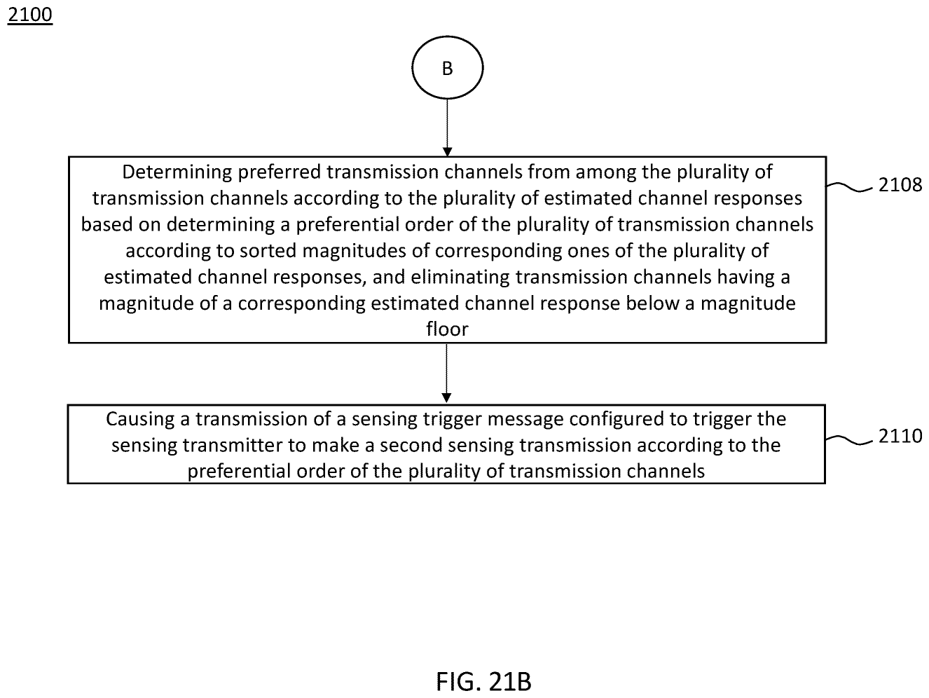

FIG. 21A and FIG. 21B depict flowchart 2100 for causing a transmission of a sensing trigger message configured to trigger sensing transmitter 504 to make a second sensing transmission according to a preferential order of plurality of transmission channels, according to some embodiments.

In a brief overview of an implementation of flowchart 2100, at step 2102, a first CSI of a first transmission channel representing a first sensing measurement performed on a first sensing transmission transmitted from sensing transmitter 504 to sensing receiver 502 in the first transmission channel is received. At step 2104, a TD-CRI of the first CSI is calculated by transforming the first CSI into the time domain. At step 2106, a plurality of estimated channel responses corresponding to a plurality of transmission channels is generated according to the TD-CRI. The plurality of estimated channel responses are generated based on extracting complex coefficients and time delays of pulses defined by the TD-CRI and calculating a frequency domain representation of a sensing space according to the complex coefficients and the time delays. At step 2108, preferred transmission channels from among the plurality of transmission channels are determined according to the plurality of estimated channel responses. The preferred transmission channels are determined based on determining a preferential order of the plurality of transmission channels according to sorted magnitudes of corresponding ones of the plurality of estimated channel responses. Further, transmission channels having a magnitude of a corresponding estimated channel response below a magnitude floor are eliminated. At step 2110, a transmission of a sensing trigger message is caused to trigger sensing transmitter 504 to make a second sensing transmission according to the preferential order of the plurality of transmission channels.

Step 2102 includes receiving a first CSI of a first transmission channel representing a first sensing measurement performed on a first sensing transmission transmitted from sensing transmitter 504 to sensing receiver 502 in the first transmission channel. According to an implementation, sensing agent 516 on sensing receiver 502, or sensing agent 526 on sensing transmitter 504 or sensing agent 536 on sensing device 506 may be configured to receive the first CSI of the first transmission channel representing the first sensing measurement performed on the first sensing transmission transmitted from sensing transmitter 504 to sensing receiver 502 in the first transmission channel.

Step 2104 includes calculating, based on the first CSI, a TD-CRI of the first CSI by transforming the first CSI into the time domain. According to an implementation, sensing agent 516 on sensing receiver 502, or sensing agent 526 on sensing transmitter 504 or sensing agent 536 on sensing device 506 may be configured to calculate the TD-CRI of the first CSI by transforming the first CSI into the time domain.

Step 2106 includes generating a plurality of estimated channel responses corresponding to a plurality of transmission channels according to the TD-CRI, wherein the plurality of estimated channel responses are generated based on extracting complex coefficients and time delays of pulses defined by the TD-CRI and calculating a frequency domain representation of a sensing space according to the complex coefficients and the time delays. According to an implementation, sensing agent 516 on sensing receiver 502, or sensing agent 526 on sensing transmitter 504 or sensing agent 536 on sensing device 506 may be configured to generate the plurality of estimated channel responses corresponding to the plurality of transmission channels according to the TD-CRI. In an implementation, sensing agent 516 on sensing receiver 502, or sensing agent 526 on sensing transmitter 504 or sensing agent 536 on sensing device 506 may generate the plurality of estimated channel responses based on extracting the complex coefficients and the time delays of pulses defined by the TD-CRI and calculating the frequency domain representation of the sensing space according to the complex coefficients and the time delays.

Step 2108 includes determining preferred transmission channels from among the plurality of transmission channels according to the plurality of estimated channel responses based on determining a preferential order of the plurality of transmission channels according to sorted magnitudes of corresponding ones of the plurality of estimated channel responses and eliminating transmission channels having a magnitude of a corresponding estimated channel response below a magnitude. According to an implementation, sensing agent 516 on sensing receiver 502, or sensing agent 526 on sensing transmitter 504 or sensing agent 536 on sensing device 506 may be configured to determine preferred transmission channels from among the plurality of transmission channels according to the plurality of estimated channel responses. In an implementation, sensing agent 516 on sensing receiver 502, or sensing agent 526 on sensing transmitter 504 or sensing agent 536 on sensing device 506 may determine the preferred transmission channels based on determining the preferential order of the plurality of transmission channels according to sorted magnitudes of corresponding ones of the plurality of estimated channel responses. Further, sensing agent 516 on sensing receiver 502, or sensing agent 526 on sensing transmitter 504 or sensing agent 536 on sensing device 506 may eliminate transmission channels having the magnitude of the corresponding estimated channel response below the magnitude floor.

Step 2110 includes causing a transmission of a sensing trigger message configured to trigger sensing transmitter 504 to make a second sensing transmission according to the preferential order of the plurality of transmission channels. According to an implementation, sensing agent 516 on sensing receiver 502, or sensing agent 526 on sensing transmitter 504 or sensing agent 536 on sensing device 506 may cause the transmission of the sensing trigger message configured to trigger sensing transmitter 504 to make the second sensing transmission according to the preferential order of the plurality of transmission channels.

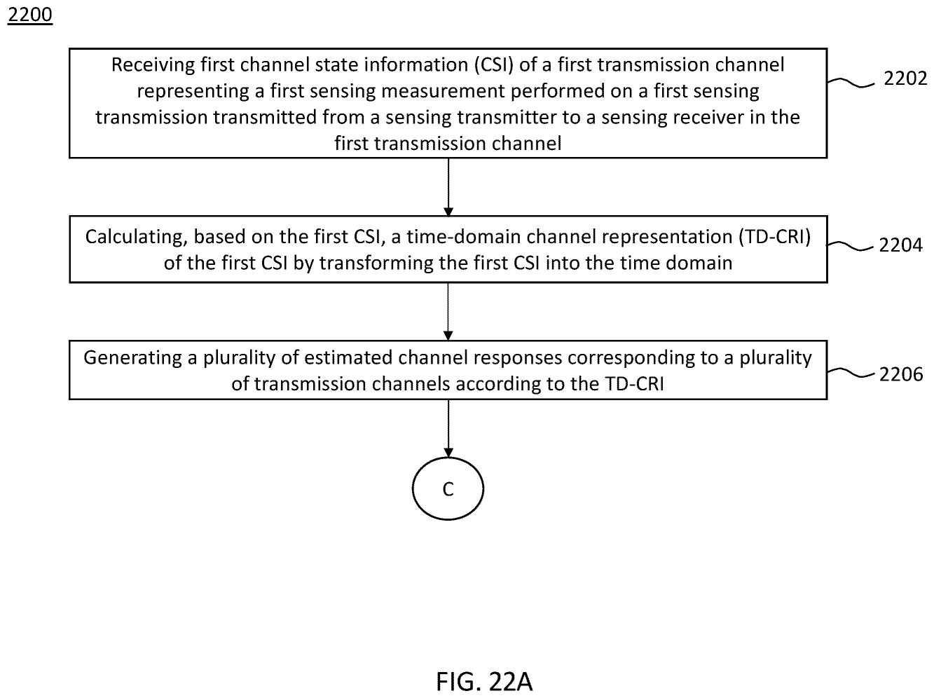

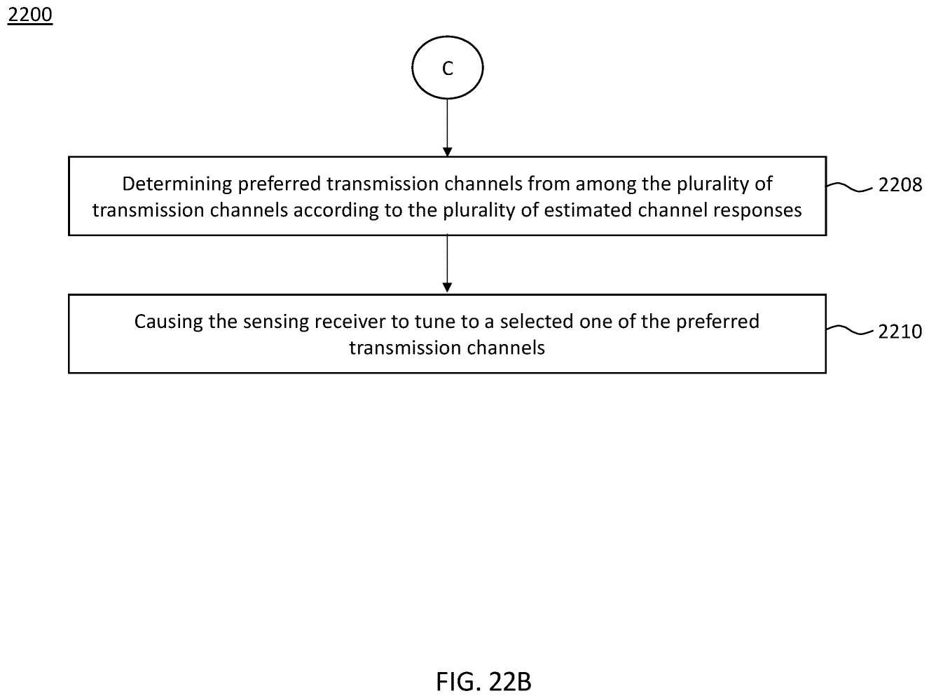

FIG. 22A and FIG. 22B depict flowchart 2200 for causing sensing receiver 502 to tune to a selected one of preferred transmission channels, according to some embodiments.

In a brief overview of an implementation of flowchart 2200, at step 2202, a first CSI of a first transmission channel representing a first sensing measurement performed on a first sensing transmission transmitted from sensing transmitter 504 to sensing receiver 502 in the first transmission channel is received. At step 2204, a TD-CRI of the first CSI is calculated by transforming the first CSI into the time domain. At step 2206, a plurality of estimated channel responses corresponding to a plurality of transmission channels is generated according to the TD-CRI. At step 2208, preferred transmission channels from among the plurality of transmission channels are determined according to the plurality of estimated channel responses. At step 2210, sensing receiver 502 is caused to tune to a selected one of the preferred transmission channels.

Step 2202 includes receiving a first CSI of a first transmission channel representing a first sensing measurement performed on a first sensing transmission transmitted from sensing transmitter 504 to sensing receiver 502 in the first transmission channel. According to an implementation, sensing agent 516 on sensing receiver 502, or sensing agent 526 on sensing transmitter 504 or sensing agent 536 on sensing device 506 may be configured to receive the first CSI of the first transmission channel representing the first sensing measurement performed on the first sensing transmission transmitted from sensing transmitter 504 to sensing receiver 502 in the first transmission channel.

Step 2204 includes calculating, based on the first CSI, a TD-CRI of the first CSI by transforming the first CSI into the time domain. According to an implementation, sensing agent 516 on sensing receiver 502, or sensing agent 526 on sensing transmitter 504 or sensing agent 536 on sensing device 506 may be configured to calculate the TD-CRI of the first CSI by transforming the first CSI into the time domain.

Step 2206 includes generating a plurality of estimated channel responses corresponding to a plurality of transmission channels according to the TD-CRI. According to an implementation, sensing agent 516 on sensing receiver 502, or sensing agent 526 on sensing transmitter 504 or sensing agent 536 on sensing device 506 may be configured to generate the plurality of estimated channel responses corresponding to the plurality of transmission channels according to the TD-CRI.

Step 2208 includes determining preferred transmission channels from among the plurality of transmission channels according to the plurality of estimated channel responses. According to an implementation, sensing agent 516 on sensing receiver 502, or sensing agent 526 on sensing transmitter 504 or sensing agent 536 on sensing device 506 may be configured to determine preferred transmission channels from among the plurality of transmission channels according to the plurality of estimated channel responses.

Step 2210 includes causing sensing receiver 502 to tune to a selected one of the preferred transmission channels. According to an implementation, sensing agent 516 on sensing receiver 502, or sensing agent 526 on sensing transmitter 504 or sensing agent 536 on sensing device 506 may cause sensing receiver 502 to tune to the selected one of the preferred transmission channels.

FIG. 23A and FIG. 23B depict flowchart 2300 for causing sensing receiver 502 to tune to a transmission channel according to a preferential order of a plurality of preferred transmission channels, according to some embodiments.

In a brief overview of an implementation of flowchart 2300, at step 2302, a first CSI of a first transmission channel representing a first sensing measurement performed on a first sensing transmission transmitted from sensing transmitter 504 to sensing receiver 502 in the first transmission channel is received. At step 2304, a TD-CRI of the first CSI is calculated by transforming the first CSI into the time domain. At step 2306, a plurality of estimated channel responses corresponding to a plurality of transmission channels is generated according to the TD-CRI. At step 2308, preferred transmission channels from among the plurality of transmission channels are determined according to the plurality of estimated channel responses, wherein the preferred transmission channels are determined based on determining a preferential order of the plurality of transmission channels according to sorted magnitudes of corresponding ones of the plurality of estimated channel responses. At step 2310, sensing receiver 502 is caused to tune to a transmission channel according to the preferential order of the plurality of preferred transmission channels.

Step 2302 includes receiving a first CSI of a first transmission channel representing a first sensing measurement performed on a first sensing transmission transmitted from sensing transmitter 504 to sensing receiver 502 in the first transmission channel. According to an implementation, sensing agent 516 on sensing receiver 502, or sensing agent 526 on sensing transmitter 504 or sensing agent 536 on sensing device 506 may be configured to receive the first CSI of the first transmission channel representing the first sensing measurement performed on the first sensing transmission transmitted from sensing transmitter 504 to sensing receiver 502 in the first transmission channel.

Step 2304 includes calculating, based on the first CSI, a TD-CRI of the first CSI by transforming the first CSI into the time domain. According to an implementation, sensing agent 516 on sensing receiver 502, or sensing agent 526 on sensing transmitter 504 or sensing agent 536 on sensing device 506 may be configured to calculate the TD-CRI of the first CSI by transforming the first CSI into the time domain.

Step 2306 includes generating a plurality of estimated channel responses corresponding to a plurality of transmission channels according to the TD-CRI. According to an implementation, sensing agent 516 on sensing receiver 502, or sensing agent 526 on sensing transmitter 504 or sensing agent 536 on sensing device 506 may be configured to generate the plurality of estimated channel responses corresponding to the plurality of transmission channels according to the TD-CRI.

Step 2308 includes determining preferred transmission channels from among the plurality of transmission channels according to the plurality of estimated channel responses based on determining a preferential order of the plurality of transmission channels according to sorted magnitudes of corresponding ones of the plurality of estimated channel responses. According to an implementation, sensing agent 516 on sensing receiver 502, or sensing agent 526 on sensing transmitter 504 or sensing agent 536 on sensing device 506 may be configured to determine preferred transmission channels from among the plurality of transmission channels according to the plurality of estimated channel responses. In an implementation, sensing device 506 may determine the preferred transmission channels based on determining the preferential order of the plurality of transmission channels according to sorted magnitudes of corresponding ones of the plurality of estimated channel responses.

Step 2310 includes causing sensing receiver 502 to tune to a transmission channel according to the preferential order of the plurality of preferred transmission channels. In an implementation, sensing agent 516 on sensing receiver 502, or sensing agent 526 on sensing transmitter 504 or sensing agent 536 on sensing device 506 may cause sensing receiver 502 to tune to the transmission channel according to the preferential order of the plurality of preferred transmission channels.

Embodiment 1 is a method for Wi-Fi sensing carried out by a sensing device including at least one processor configured to execute instructions. The method comprises receiving, by the at least one processor, first channel state information (CSI) of a first transmission channel representing a first sensing measurement performed on a first sensing transmission transmitted from a sensing transmitter to a sensing receiver in the first transmission channel; calculating, based on the first CSI, a time-domain channel representation (TD-CRI) of the first CSI by transforming the first CSI into the time domain; generating, by the at least one processor, a plurality of estimated channel responses corresponding to a plurality of transmission channels according to the TD-CRI; and determining, by the at least one processor, one or more preferred transmission channels from among the plurality of transmission channels according to the plurality of estimated channel responses.

Embodiment 2 is the method of embodiment 1, wherein the TD-CRI is a filtered TD-CRI or a full TD-CRI.

Embodiment 3 is the method of embodiment 1 or 2, wherein generating the plurality of estimated channel responses includes: extracting complex coefficients and time delays of pulses defined by the TD-CRI; and calculating a frequency domain representation of one or more frequency bands according to the complex coefficients and the time delays.

Embodiment 4 is the method of embodiment 3, wherein generating the plurality of estimated channel responses further includes: calculating each of the plurality of estimated channel responses as a response to a frequency of each of the plurality of transmission channels in the one or more frequency bands according to the frequency domain representation of the sensing space.

Embodiment 5 is the method of embodiment 4, wherein the frequency of each of the plurality of transmission channels represents a tunable frequency of the sensing transmitter or a range of tunable frequencies of the sensing transmitter.

Embodiment 6 is the method of any of embodiments 1-5, wherein determining the one or more preferred transmission channels includes determining a preferential order of the plurality of transmission channels according to sorted magnitudes of corresponding ones of the plurality of estimated channel responses.

Embodiment 7 is the method of embodiment 6, wherein determining the one or more preferred transmission channels further includes determining a preferential order of sensing channel frequencies according to a mapping between the plurality of transmission channels and tunable frequencies of the sensing transmitter.

Embodiment 8 is the method of embodiment 6 or 7, wherein determining the one or more preferred transmission channels further includes eliminating transmission channels having a magnitude of a corresponding estimated channel response below a magnitude floor.

Embodiment 9 is the method of any of embodiments 1-8, further comprising causing, by the at least one processor, transmission of a sensing trigger message configured to trigger the sensing transmitter to make a second sensing transmission in a selected one of the one or more preferred transmission channels.

Embodiment 10 is the method of any of embodiments 6-9, further comprising causing, by the at least one processor, transmission of a sensing trigger message configured to trigger the sensing transmitter to make a second sensing transmission according to the preferential order of the plurality of transmission channels.

Embodiment 11 is the method of any of embodiments 1-10, further comprising causing, by the at least one processor, the sensing receiver to tune to the selected one of the one or more preferred transmission channels.

Embodiment 12 is the method of any of embodiments 6-11, further comprising causing, by the at least one processor, the sensing receiver to tune to a transmission channel according to the preferential order of the plurality of transmission channels.

Embodiment 13 is the method of any of embodiments 1-12, further comprising: receiving, by the at least one processor, second channel state information (CSI) of a selected one of the one or more preferred transmission channels representing a second sensing measurement performed on a second sensing transmission transmitted from the sensing transmitter to the sensing receiver in the selected one of the one or more preferred transmission channels.

Embodiment 14 is the method of any of embodiments 1-13, further comprising: prioritizing, by the at least one processor, second CSI determined based on second sensing measurements performed on second sensing transmissions in the one or more preferred transmission channels over third CSI determined based on third sensing measurements performed on third sensing transmissions in non-preferred transmission channels.

Embodiment 15 is the method of embodiment 13 or 14, further comprising: analyzing, by the at least one processor, second CSI determined based on second sensing measurements performed on second sensing transmissions in the one or more preferred transmission channels while in a first mode; and analyzing, by the at least one processor, third CSI determined based on third sensing measurements performed on third sensing transmissions in preferred and non-preferred transmission channels while in a second mode.

Embodiment 16 is the method of any of embodiments 6-15, further comprising: receiving one or more input parameters; and selecting the one or more preferred transmission channels according to the preferential order of the plurality of transmission channels and the one or more input parameters.

Embodiment 17 is a system for Wi-Fi sensing. The system comprises a sensing device including at least one processor configured to execute instructions for receiving first channel state information (CSI) of a first transmission channel representing a first sensing measurement performed on a first sensing transmission transmitted from a sensing transmitter to a sensing receiver in the first transmission channel; calculating, based on the first CSI, a time-domain channel representation (TD-CRI) of the first CSI by transforming the first CSI into the time domain; generating a plurality of estimated channel responses corresponding to a plurality of transmission channels according to the TD-CRI; and determining one or more preferred transmission channels from among the plurality of transmission channels according to the plurality of estimated channel responses.

Embodiment 18 is the system of embodiment 17, wherein the TD-CRI is a filtered TD-CRI or a full TD-CRI.

Embodiment 19 is the system of embodiment 17 or 18, wherein generating the plurality of estimated channel responses is performed by: extracting complex coefficients and time delays of pulses defined by the TD-CRI; and calculating a frequency domain representation of one or more frequency bands according to the complex coefficients and the time delays.

Embodiment 20 is the system of embodiment 19, wherein generating the plurality of estimated channel responses is performed by: calculating each of the plurality of estimated channel responses as a response to a frequency of each of the plurality of transmission channels in the one or more frequency bands according to the frequency domain representation of the sensing space.

Embodiment 21 is the system of embodiment 20, wherein the frequency of each of the plurality of transmission channels represents a tunable frequency of the sensing transmitter or a range of tunable frequencies of the sensing transmitter.

Embodiment 22 is the system of any of embodiments 17-21, wherein determining the one or more preferred transmission channels is performed by determining a preferential order of the plurality of transmission channels according to sorted magnitudes of corresponding ones of the plurality of estimated channel responses.

Embodiment 23 is the system of embodiment 22, wherein determining the one or more preferred transmission channels further is performed by determining a preferential order of sensing channel frequencies according to a mapping between the plurality of transmission channels and tunable frequencies of the sensing transmitter.

Embodiment 24 is the system of any embodiment 22 or 23, wherein determining the one or more preferred transmission channels is performed by eliminating transmission channels having a magnitude of a corresponding estimated channel response below a magnitude floor.

Embodiment 25 is the system of any of embodiments 17-24, wherein the at least one processor further includes instructions for causing transmission of a sensing trigger message configured to trigger the sensing transmitter to make a second sensing transmission in a selected one of the one or more preferred transmission channels.

Embodiment 26 is the system of any of embodiments 17-25, wherein the at least one processor further includes instructions for causing transmission of a sensing trigger message configured to trigger the sensing transmitter to make a second sensing transmission according to the preferential order of the plurality of transmission channels.

Embodiment 27 is the system of any of embodiments 17-26, wherein the at least one processor further includes instructions for causing the sensing receiver to tune to the selected one of the one or more preferred transmission channels.

Embodiment 28 is the system of any of embodiments 22-27, wherein the at least one processor further includes instructions for causing the sensing receiver to tune to a transmission channel according to the preferential order of the plurality of transmission channels.

Embodiment 29 is the system of any of embodiments 17-28, wherein the at least one processor further includes instructions for: receiving, by the at least one processor, second channel state information (CSI) of a selected one of the one or more preferred transmission channels representing a second sensing measurement performed on a second sensing transmission transmitted from the sensing transmitter to the sensing receiver in the selected one of the one or more preferred transmission channels.

Embodiment 30 is the system of any of embodiments 17-29, wherein the at least one processor further includes instructions for: prioritizing, by the at least one processor, second CSI determined based on second sensing measurements performed on second sensing transmissions in the one or more preferred transmission channels over third CSI determined based on third sensing measurements performed on third sensing transmissions in non-preferred transmission channels.

Embodiment 31 is the system of embodiment 29 or 30, wherein the at least one processor further includes instructions for: analyzing, by the at least one processor, second CSI determined based on second sensing measurements performed on second sensing transmissions in the one or more preferred transmission channels while in a first mode; and analyzing, by the at least one processor, third CSI determined based on third sensing measurements performed on third sensing transmissions in preferred and non-preferred transmission channels while in a second mode.

Embodiment 32 is the system of any of embodiments 22-31, wherein the at least one processor further includes instructions for: receiving one or more input parameters; and selecting the one or more preferred transmission channels according to the preferential order of the plurality of transmission channels and the one or more input parameters.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing device including at least one processor configured to execute instructions, the method comprising:
receiving, by the at least one processor, first channel state information (CSI) of a first transmission channel representing a first sensing measurement performed on a first sensing transmission transmitted from a sensing transmitter to a sensing receiver in the first transmission channel;
calculating, by the at least one processor, based on the first CSI, a time-domain channel representation (TD-CRI) of the first CSI by transforming the first CSI into the time domain;
generating, by the at least one processor, a plurality of estimated channel responses corresponding to a plurality of transmission channels according to the TD-CRI; and
determining, by the at least one processor, one or more preferred transmission channels from among the plurality of transmission channels according to the plurality of estimated channel responses.

2. (canceled)

3. The method of claim 1, wherein generating the plurality of estimated channel responses includes:
extracting complex coefficients and time delays of pulses defined by the TD-CRI; and
calculating a frequency domain representation of one or more frequency bands according to the complex coefficients and the time delays.

4. The method of claim 3, wherein generating the plurality of estimated channel responses further includes:
calculating each of the plurality of estimated channel responses as a response to a frequency of each of the plurality of transmission channels in the one or more frequency bands according to the frequency domain representation of the one or more frequency bands.

5. (canceled)

6. The method of claim 1, wherein determining the one or more preferred transmission channels includes determining a preferential order of the plurality of transmission channels according to sorted magnitudes of corresponding ones of the plurality of estimated channel responses.

7. The method of claim 6, wherein determining the one or more preferred transmission channels further includes determining a preferential order of sensing channel frequencies according to a mapping between the plurality of transmission channels and at least one of tunable frequencies of the sensing transmitter and tunable frequencies of the sensing receiver.

8. The method of claim 6, wherein determining the one or more preferred transmission channels further includes eliminating transmission channels having a magnitude of a corresponding estimated channel response below a magnitude floor.

9. The method of claim 1, further comprising causing, by the at least one processor, transmission of a sensing trigger message configured to trigger the sensing transmitter to make a second sensing transmission in a selected one of the one or more preferred transmission channels.

10. (canceled)

11. The method of claim 1, further comprising causing, by the at least one processor, the sensing receiver to tune to the selected one of the one or more preferred transmission channels.

12. (canceled)

13. The method of claim 1, further comprising:
receiving, by the at least one processor, second channel state information (CSI) of a selected one of the one or more preferred transmission channels representing a second sensing measurement performed on a second sensing transmission transmitted from the sensing transmitter to the sensing receiver in the selected one of the one or more preferred transmission channels.

14. The method of claim 1, further comprising:
prioritizing, by the at least one processor, second CSI determined based on second sensing measurements performed on second sensing transmissions in the one or more preferred transmission channels over third CSI determined based on third sensing measurements performed on third sensing transmissions in non-preferred transmission channels.

15. (canceled)

16. The method of claim 6, further comprising:
receiving one or more input parameters; and
selecting the one or more preferred transmission channels according to the preferential order of the plurality of transmission channels and the one or more input parameters.

17. A system for Wi-Fi sensing, comprising:
a sensing device including at least one processor configured to execute instructions for:
receiving first channel state information (CSI) of a first transmission channel representing a first sensing measurement performed on a first sensing transmission transmitted from a sensing transmitter to a sensing receiver in the first transmission channel;
calculating, based on the first CSI, a time-domain channel representation (TD-CRI) of the first CSI by transforming the first CSI into the time domain;
generating a plurality of estimated channel responses corresponding to a plurality of transmission channels according to the TD-CRI; and
determining one or more preferred transmission channels from among the plurality of transmission channels according to the plurality of estimated channel responses.

18. (canceled)

19. The system of claim 17, wherein generating the plurality of estimated channel responses is performed by:
extracting complex coefficients and time delays of pulses defined by the TD-CRI; and
calculating a frequency domain representation of one or more frequency bands according to the complex coefficients and the time delays.

20. The system of claim 19, wherein generating the plurality of estimated channel responses is performed by:
calculating each of the plurality of estimated channel responses as a response to a frequency of each of the plurality of transmission channels in the one or more frequency bands according to the frequency domain representation of the one or more frequency bands.

21. (canceled)

22. The system of claim 17, wherein determining the one or more preferred transmission channels is performed by determining a preferential order of the plurality of transmission channels according to sorted magnitudes of corresponding ones of the plurality of estimated channel responses.

23. The system of claim 22, wherein determining the one or more preferred transmission channels further is performed by determining a preferential order of sensing channel frequencies according to a mapping between the plurality of transmission channels and at least one of tunable frequencies of the sensing transmitter and tunable frequencies of the sensing receiver.

24. (canceled)

25. The system of claim 17, wherein the at least one processor further includes instructions for causing transmission of a sensing trigger message configured to trigger the sensing transmitter to make a second sensing transmission in a selected one of the one or more preferred transmission channels.

26. (canceled)

27. The system of claim 17, wherein the at least one processor further includes instructions for causing the sensing receiver to tune to the selected one of the one or more preferred transmission channels.

28. (canceled)

29. The system of claim 17, wherein the at least one processor further includes instructions for:
receiving, by the at least one processor, second channel state information (CSI) of a selected one of the one or more preferred transmission channels representing a second sensing measurement performed on a second sensing transmission transmitted from the sensing transmitter to the sensing receiver in the selected one of the one or more preferred transmission channels.

30. The system of claim 17, wherein the at least one processor further includes instructions for:
prioritizing, by the at least one processor, second CSI determined based on second sensing measurements performed on second sensing transmissions in the one or more preferred transmission channels over third CSI determined based on third sensing measurements performed on third sensing transmissions in non-preferred transmission channels.

31. (canceled)

32. (canceled)
